(19) United States
(12) Patent Application Publication
(10) Pub. No.: US 2010/0197482 A1
(43) Pub. Date: Aug. 5, 2010

(54) SOLID METAL COMPOUND, PREPARATIONS AND USES THEREOF

(76) Inventors: Jean-Marie Basset, Caluire (FR); Nicolas Merle, Villeurbanne (FR); Francois Stoffelbach, Villejuif (FR); Mostafa Taoufik, Villeurbanne (FR); Jean Thivolle-Cazat, Fontaines sur Saone (FR)

Correspondence Address: NIXON & VANDERHYE, PC, 901 NORTH GLEBE ROAD, 11TH FLOOR, ARLINGTON, VA, 22203, US

(21) Appl. No.: 12/733,809

(22) PCT Filed: Sep. 25, 2008
(86) PCT No.: PCT/GB2008/003258

§ 371 Date: Mar. 22, 2010

(30) Foreign Application Priority Data
Oct. 3, 2007 (EP) 07253920.8

(51) Int. Cl. B01J 31/12; B01J 21/04

(52) U.S. Cl. 502/154; 502/152

(57) ABSTRACT

The invention relates to a solid metal compound comprising (i) a solid support comprising aluminium oxide, (ii) at least one first metal compound (C1) selected from metal hydrides, organometallic compounds and organometallic hydrides, and comprising a metal (M1) selected from the lanthanides, the actinides and the metals of Groups 4 to 7 of the Periodic Table of the Elements, and (iii) at least one second metal compound (C2) comprising a metal (M2) selected from the metals of Groups 8 to 10 of said Table. The compounds (C1) and (C2) are preferably supported on, particularly grafted onto the solid support. The invention also relates to processes for preparing the solid metal compound, preferably comprising stage (1) comprising dispersing and preferably grafting (i) an organometallic precursor (Pr1) comprising the metal (M1) and (ii) a precursor (Pr2) comprising the metal (M2) onto the support, so as to produce the solid metal compound, and preferably stage (2) comprising contacting the solid metal compound thus obtained with hydrogen and/or a reducing agent. The invention also relates to the use of the solid metal compound in processes comprising hydrocarbon reactions optionally in the presence of hydrogen, and preferably involving the splitting and recombining of carbon-carbon and/or carbon-hydrogen and/or carbon-metal bonds, so as to produce final hydrocarbons different from the starting ones. The solid metal compound can be used in processes comprising alkane and/or alkene metathesis, non-oxidative methane coupling, alkene oligomerisation, methane-olysis of hydrocarbons, cross-metathesis and hydrogenolysis of hydrocarbons, e.g. saturated hydrocarbons, hydrocarbon polymers/oligomers or waxes, in the presence of hydrogen.

The present invention relates to a solid metal compound, its preparation processes and its uses, in particular as a catalyst in metathesis or hydrogenolysis reactions of hydrocarbon compounds.

American Patent U.S. Pat. No. 3,699,035 describes a process for producing gasoline from a hexane-rich hydrocarbon feed. The process comprises averaging hexane with one or more alkanes and catalytically reforming the resulting hydrocarbons. The averaging reaction is carried out at a relatively high temperature, e.g. at about 427° C., using a catalyst mass having hydrocarbon dehydrogenation activity and olefin disproportionation activity. The catalyst mass comprises a component selected from metals of Group 8 to 10 and a component selected from Group 6. More particularly, the preferred catalyst mass consists of platinum on alumina particles mixed with tungsten oxide on silica particles.

International Patent Application WO 98/02244 describes a process for the metathesis of alkanes in which one or more alkanes are reacted on a solid catalyst comprising a metal hydride grafted onto a solid support. The metal of the metal hydride can be chosen from the transition metals of Groups 5 to 6 of the Periodic Table of the Elements, preferably from tantalum, tungsten and chromium. The solid support can be chosen from numerous solid oxides, preferably from silica, alumina, silica-alumina, niobium oxide and zeolites. Amongst the catalysts used for alkane metathesis, it is recommended to select tantalum hydride, tungsten hydride or chromium hydride grafted onto silica or silica-alumina. The examples show the preparations of a tantalum hydride grafted onto a silica and a tungsten hydride grafted onto a silica.

International Patent Application WO 2004/089541 describes a supported metal compound comprising a support based on aluminium oxide onto which is grafted a tungsten hydride. The support can be a mixed aluminium oxide comprising an aluminium oxide combined with at least one other oxide of an element chosen from the metals of Groups 1 to 13 and the Group 14 (with the exception of carbon) of the Periodic Table of the Elements. The other oxide can be an oxide of a metal chosen from the alkaline metals, the alkaline-earth metals, the transition metals and the elements of Groups 13 and 14 (with the exception of carbon) of said Table. More particularly, the other oxide can be an oxide of a transition metal selected from the metals of Groups 3 to 11 of said Table, in particular the elements 21 (i.e. Sc) to 29 (i.e. Cu), 39 (i.e. Y) to 47 (i.e. Ag), 57 (i.e. La) to 79 (i.e. Au) (including the lanthanides) and the actinides. Preferably, the other oxide can be an oxide of a metal chosen from the transition metals of Groups 3 to 7, the lanthanides, the actinides and the elements of Groups 13 and 14 (with the exception of carbon) of said Table. More particularly, the other oxide combined with the aluminium oxide is chosen from oxides of silicon, boron, gallium, germanium, titanium, zirconium, cerium vanadium, niobium, tantalum, chromium, molybdenum and tungsten.

International Patent Application WO 2006/013263 describes a process for metathesis of compounds containing an olefinic double bond, in particular olefins, comprising contacting said compounds with a supported metal compound comprising an aluminium oxide-based support to which a tungsten hydride is grafted.

International Patent Application WO 2006/013251 describes a process for converting ethylene into propylene, comprising contacting ethylene with a supported metal compound comprising an aluminium oxide-based support to which a tungsten hydride is grafted.

The Periodic Table of the Elements mentioned above and below is that drawn up by the IUPAC in 1991, in which the groups are numbered from 1 to 18. It is found, for instance, in “CRC Handbook of Chemistry and Physics” 76^{th} Edition (1995-1996) by David R. Lide and published by CRC Press, Inc. (USA).

It was found surprisingly that among all the possible compositions of a solid metal compound comprising a tungsten hydride supported onto an aluminium oxide as disclosed in International Patent Application 2004/089541, there was no indication that a specific combination of at least two metals belonging to two different groups of the Periodic Table of the Elements with a solid support based on aluminium oxide, could result in a solid metal compound capable of acting as catalyst and improving catalytic reactions of saturated or unsaturated hydrocarbons. The improvements can be preferably observed in the following reactions: alkane metathesis, alkane hydrogenolysis, alkene (olefin) metathesis, alkene (olefin) oligomerisation, conversion of ethylene into propylene and conversion of isobutene into neohexene. More particularly, these reactions can be performed not only at relatively low temperatures, e.g. lower than 400° C., preferably lower than 350° C. or even equal to or lower than 300° C., but also with a substantially increased catalytic activity which can be particularly more stable with time, and/or an enhanced selectivity in the hydrocarbons produced (e.g. alkanes or alkenes). These results can be obtained in catalytic reactions involving alkanes, particularly linear alkanes or preferably branched alkanes, especially branched alkanes having an “iso” structure, and also in catalytic reactions involving alkenes, e.g. olefins or alpha-olefins, particularly linear alkenes or branched alkenes e.g. having an “iso” structure.

The present invention relates to a solid metal compound comprising (i) a solid support comprising aluminium oxide, (ii) at least one first metal compound (C1) selected from metal hydrides, organometallic compounds and organometallic hydrides, and comprising a metal (M1) selected from the lanthanides, the actinides and the metals of Groups 4 to 7 of the Periodic Table of the Elements, and (iii) at least one second metal compound (C2) comprising a metal (M2) selected from the metals of Groups 8 to 10 of said Table.

In the solid metal compound, the support can be a solid support containing aluminium oxide, preferably any solid support where the aluminium oxide is accessible at the surface of said support. The support can be chosen from homogeneous supports comprising aluminium oxide, in particular having a homogeneous composition through the whole mass of the support, i.e. from the centre to the surface of the support. It can also be chosen from heterogeneous supports containing aluminium oxide, in particular comprising aluminium oxide substantially at the surface of the support. In the case of a heterogeneous support, the support can comprise aluminium oxide essentially deposited, supported or grafted on/onto a solid which can itself an organic or preferably an inorganic solid support, more particularly chosen from metals, oxides, sulphides, salts or carbon, preferably from silica and metal oxides.

The support can have a specific surface area (B.E.T.) chosen from 0.1 to 3000 m²/g, preferably from 0.5 to 1000 m²/g, more particularly from 0.5 to 800 m²/g. The specific surface area (B.E.T.) is measured according to the standard ISO 9277 (1995).

The support can be more particularly chosen from aluminium oxide, mixed aluminium oxides and modified aluminium oxides, in particular ones modified by one or more elements of Groups 15 to 17 of the Periodic Table of the Elements.

By aluminium oxide (also simply called alumina) is generally meant an aluminium oxide substantially free from any other oxide (or containing less than 2 wt % of one or more other oxides generally present in the form of impurities). If it contains 2 wt % or more of one or more other oxides, it is generally agreed to regard the oxide as a mixed aluminium oxide, i.e. an aluminium oxide mixed or combined with at least one other oxide.

The support can be an aluminium oxide selected from porous alumina, non-porous alumina and mesoporous alumina.

Porous alumina is often called “activated alumina” or else “transition alumina”. It generally corresponds to various partially hydroxylated aluminium oxides. Porous alumina is generally obtained by a so-called “activation” treatment which can comprise a thermal (or dehydration) treatment of a precursor generally selected from hydroxides of aluminium (e.g. tri-hydroxides), hydroxides of aluminium oxide and gelatinous hydroxides of aluminium. The activation treatment makes it possible to remove the water contained in the precursor, and also partially the hydroxyl groups, thus allowing some residual hydroxyl groups and a specific porous structure to remain. The surface of a porous alumina generally comprises a complex mixture of aluminium atoms, oxygen atoms and hydroxyl ions that combine according to specific crystalline forms and which can produce both acid and basic sites. It is thus possible to choose as a solid support a porous alumina selected from γ-alumina (gamma-alumina), η-alumina (eta-alumina), δ-alumina (delta-alumina), θ-alumina (theta-alumina), κ-alumina (kappa-alumina), ρ-alumina (rho-alumina) and χ-alumina (ksi- or chi-alumina), more particularly from γ-alumina and η-alumina. In a porous alumina, the various crystalline forms essentially depend on the choice of the precursor and the conditions of the activation treatment, e.g. the temperature and the pressure. The activation treatment can be carried out under a current of air or another gas, particularly an inert gas, e.g. nitrogen, at a temperature chosen from 100 to 1000° C., preferably from 200 to 1000° C.

The support can be a porous alumina or else more particularly a semi-porous alumina generally obtained by an activation treatment as previously described, in particular at a temperature chosen from 600 to 1000° C. The semi-porous alumina can comprise a mixture of porous alumina with non-porous alumina, in particular a mixture of at least one of the above-mentioned porous aluminas, e.g. selected from γ-alumina, η-alumina, δ-alumina, θ-alumina, χ-alumina, ρ-alumina and κ-alumina, with a non-porous alumina, e.g. α-alumina (alpha-alumina), for instance in a weight ratio of porous to non-porous aluminas chosen from 20:80 to 80:20.

Porous alumina generally is the thermal decomposition product of tri-hydroxides of aluminium, hydroxides of aluminium oxide (or hydrates of aluminium oxide), or gelatinous hydroxides of aluminium (or alumina gels).

Tri-hydroxides of aluminium having the general formula Al(OH)₃ or Al₂O₃,3H₂O can exist in various crystalline forms, e.g. gibbsite or hydrargillite (Al(OH)₃-α), bayerite (Al(OH)₃-β), or nordstrandite. Tri-hydroxides of aluminium can be obtained by precipitation from aluminium salts, preferably in alkaline solutions.

Hydroxides of aluminium oxide having the general formula AlO(OH) or Al₂O₃,H₂O can exist in various crystalline forms, e.g. diaspore (AlO(OH)-β) or boehmite (AlO(OH)-α). Diaspore can be found in certain types of clay and bauxite, and can be synthesised by a thermal treatment of gibbsite, e.g. at 150° C. about, or by a hydrothermal treatment of boehmite, e.g. at 380° C. about and under a pressure of 50 MPa. Boehmite can easily be obtained by heating the gelatinous precipitate formed by cold treating solutions of aluminium salts with ammonia. Hydroxides of aluminium oxide can also be obtained by hydrolysis of aluminium alcoholates.

Gelatinous hydroxides of aluminium (or alumina gels) generally are polyhydroxides of aluminium, in particular having the general formula (1):

nAl(OH)₃, (n−1)H₂O (1)

wherein n is a number chosen from 1 to 8. Gelatinous hydroxides of aluminium can be obtained by one of the processes chosen from thermal decomposition of an aluminium salt, e.g. aluminium chloride, or from electrolysis of aluminium salts, e.g. a mixture of aluminium sulphate with alkaline sulphate, or from hydrolysis of aluminium alcoholates, e.g. aluminium methylate, or from precipitation from aluminates, e.g. alkaline aluminates or alkaline-earth aluminates, or from precipitation from aluminium salts, e.g. by contacting an aqueous solution of Al₂(SO₄)₃ with ammonia, or an aqueous solution of NaAlO₂ with an acid, or an aqueous solution of NaAlO₂ with an aqueous solution of Al₂(SO₄)₃. The precipitates thus obtained can then undergo ageing and drying so as to eliminate water. Gelatinous hydroxides of aluminium generally come in the form of amorphous alumina gels, e.g. in the form of a pseudo-boehmite.

Porous alumina can have a specific surface area (B.E.T.) chosen from 100 to 3000 m²/g, preferably from 100 to 2000 m²/g, particularly from 100 to 1000 m²/g, especially from 200 to 800 m²/g. In addition, porous alumina can exhibit a specific pore volume equal to or less than 1 cm³/g, preferably equal to or less than 0.9 cm³/g, more particularly equal to or less than 0.6 cm³/g.

The support can also be a non-porous alumina, preferably α-alumina (alpha-alumina), generally known under the expression of “calcined alumina” or “flame alumina”. In the nature, α-alumina exists under the name of “corundum”. It can be generally synthesised by a thermal treatment or a calcinations of a precursor chosen in particular from aluminium salts, hydroxides of aluminium oxide, tri-hydroxides of aluthinium and aluminium oxides, e.g. γ-alumina, at a temperature of more than 1000° C., preferably more than 1100° C. It can contains oxide impurities generally selected from Fe₂O₃, SiO₂, TiO₂, CaO, Na₂O, K₂O, MgO, SrO, BaO and Li₂O, generally in proportions of less than 2 wt %, preferably less than 1 wt %. Non-porous alumina, e.g. α-alumina, can have a specific surface area (B.E.T.) chosen from 0.1 to 300 m²/g, preferably from 0.5 to 300 m²/g, more particularly from 0.5 to 250 m²/g.

The support can also be a mesoporous alumina, in particular having a specific surface area (B.E.T.) chosen from 100 to 800 m²/g, preferably from 100 to 600 m²/g. A mesoporous alumina generally can have pores with a width of from 2 nm to 0.05 μm.

The support can also be a mixed aluminium oxide. By mixed aluminium oxide is generally meant an aluminium oxide combined with one or more other oxides, preferably in a proportion of from 2 to less than 80 wt %, more particularly from 2 to less than 50 wt %, in particular from 2 to less than 40 wt %. The other oxide can be an oxide of a metal or an element chosen from the metals and the elements of Groups 1 to 14, with the exception of carbon, of the Periodic Table of the Elements. It can be in particular selected from the alkaline metals, the alkaline-earth metals, the transition metals of Groups 3 to 12, the elements of Group 14 (with the exception of carbon) of the Periodic Table of the Elements, the lanthanides and the actinides. The other oxide combined with the aluminium oxide can be selected from oxides of lithium, sodium, calcium, beryllium, magnesium, zinc, manganese, iron, cobalt, silicon, boron, gallium, germanium, titanium, zirconium, cerium, vanadium, niobium, tantalum, chromium, molybdenum and tungsten. A mixed aluminium oxide can be preferably combined with one or more other oxides selected from oxides of silicon, boron, titanium and niobium, and can be particularly chosen from the following mixed aluminium oxides: Al₂O₃/SiO₂, Al₂O₃/B₂O₃, Al₂O₃/SiO₂/B₂O₃, Al₂O₃/TiO₂ and Al₂O₃/Nb₂O₅.

A mixed aluminium oxide can be selected from anhydrous aluminates, spinels and alumino-silicates. In particular, the anhydrous aluminates can be chosen from. anhydrous alkaline aluminates, e.g. anhydrous lithium aluminate (LiAlO₂) or anhydrous sodium aluminate (Na₂O, Al₂O₃), and from anhydrous alkaline-earth aluminates, e.g. anhydrous tricalcium aluminate (3CaO, Al₂O₃) or anhydrous beryllium aluminate (BeO, Al₂O₃). The spinels can be particularly chosen from aluminium oxides combined with one or more oxides of divalent metals, e.g. magnesium spinel (MgAl₂O₄), calcium spinel (CaAl₂O₄), zinc spinel (ZnAl₂O4), manganese spinel (MnAl₂O₄), iron spinel (FeAl₂O₄) or cobalt spinel (CoAl₂O₄). The alumino-silicates can be chosen in particular from clays, talcum, micas, feldspar, micro-porous alumino-silicates, in particular molecular sieves, and zeolites.

The support can also be a modified aluminium oxide, in particular one modified by one or more elements of Groups 15 to 17, preferably of Groups 16 and 17 of the Periodic Table of the Elements, more particularly selected from phosphorus, sulphur, fluorine and chlorine. The support can also be selected from alumina superacids, sulphated aluminium oxides, sulphured aluminium oxides, chlorinated aluminium oxides and fluorinated aluminium oxides.

The support can be a homogeneous support comprising aluminium oxide, i.e. having a homogeneous composition in particular through the whole mass of the support. The support can also be a heterogeneous support comprising aluminium oxide, in which support the aluminium oxide, or the mixed aluminium oxide, or the modified aluminium oxide, as previously described, is essentially arranged at the surface of a solid support, the centre of the solid support being essentially composed of an inorganic or organic solid, chosen in particular from metals, oxides, sulphides, salts and carbon, preferably from silica or metal oxides. The heterogeneous support can be prepared by dispersion, precipitation and/or grafting onto the solid of one the above-mentioned precursors based on aluminium oxide. The precursor can be chosen from hydroxides of aluminium, more particularly from tri-hydroxides of aluminium, hydroxides of aluminium oxide and gelatinous hydroxides of aluminium. The gelatinous hydroxides of aluminium as previously described are preferred and are generally known under the expression of “alumina gels” or “amorphous alumina”. The preparation of a heterogeneous support can be carried out by employing such a precursor by means of a sol-gel, or with the help of an organometallic compound particularly for the grafting onto the solid.

The support generally are in the form of particles which can have any shape and any size, preferably a mean size chosen from 10 nm to 10 mm, e.g. from 20 nm to 5 mm. The particles of the support can come as such, or can be shaped so as to have a specific shape, preferably a spherical, spheroidal, hemispherical, hemispheroidal, cylindrical, parallelepipedic or cubic shape, or the shape of rings, pellets, discs or granules.

The solid metal compound of the present invention also comprises at least one first metal compound (C1) selected from metal hydrides, organometallic compounds and organometallic hydrides, said compound (C1) comprising a metal (M1) selected from the lanthanides, the actinides and the metals of Groups 4 to 7, preferably selected from the lanthanides and the metals of Groups 4 to 7, more particularly from the metals of Groups 4 to 7 of the Periodic Table of the Elements.

The first metal compound (C1) may comprise a metal (M1) advantageously selected from lanthanum, cerium, neodymium, samarium, lutetium, titanium, zirconium, hafnium, vanadium, niobium, tantalum, chromium, molybdenum, tungsten and rhenium. Preferably the metal (M1) is selected from zirconium, hafnium, vanadium, niobium, tantalum, chromium, molybdenum, tungsten and rhenium, and more particularly from zirconium, niobium, tantalum, molybdenum, tungsten and rhenium.

The first metal compound (C1) is selected from metal hydrides, organometallic compounds and organometallic hydrides. It can be supported on, or preferably grafted onto the solid support comprising aluminium oxide. By first metal compound (C1) grafted onto the solid support comprising aluminium oxide is generally meant an atom of the metal (M1) linked to said solid support, preferably by one or more single bonds, particularly to at least one oxygen atom of the aluminium oxide, e.g. according to the general formula (M1−OAl) or (AlO−M1−OAl).

By first metal compound (C1) selected from metal hydrides is generally meant an atom of the metal (M1) linked to one or more hydrogen atoms by a single bond, e.g. according to the general formula (M1-H). The number of hydrogen atoms linked to a metal (M1) atom can depend on the formal oxidation state of said metal (M1) and optionally on the number of single bonds linking said metal (M1) atom to the solid support, particularly to oxygen atom of the aluminium oxide, e.g. according to the general formula (M1−OAl), when the first metal compound (C1) is particularly grafted onto the solid support.

By first metal compound (C1) selected from organometallic compounds is generally meant an atom of the metal (M1) linked to one or more hydrocarbon radicals (R) identical or different, particularly by single or multiple carbon-metal (M1) bonds, e.g. a single bond (M1-R), a double bond (M1═R) or a triple bond (M1≡R.). The number of thethydrocarbon radicals (R) linked to a metal (M1) atom can depend on the formal oxidation state of said metal (M1), on the type of the single or multiple carbon-metal (M1) bonds, and optionally on the number of single bonds linking said metal (M1) atom to the solid support, particularly to oxygen atom of the aluminium oxide, e.g. according to the general formula (M1−OAl), when the first metal compound (C1) is particularly grafted onto the solid support.

By first metal compound (C1) selected from organometallic hydrides is generally meant an atom of the metal (M1) simultaneously linked to one or more hydrocarbon radicals (R) identical or different, particularly by single or multiple carbon-metal (M1) bonds, e.g. a single bond (M1-R), a double bond (M1═R) or a triple bond (M1≡R), and to one or more hydrogen atoms by a single bond, e.g. according to the general formula (M1-H). The total number of the hydrocarbon radicals (R) and of the hydrogen atoms linked to a metal (M1) atom can depend on the formal oxidation state of said metal (M1), on the type of the single or multiple carbon-metal (M1) bonds, and optionally on the number of single bonds linking said metal (M1) atom to the solid support, particularly to oxygen atom of the aluminium oxide, e.g. according to the general formula (M1−OAl), when said first metal compound (C1) is particularly grafted onto the solid support.

The first metal compound (C1) is particularly selected from the organometallic compounds and the organometallic hydrides, comprising one or more hydrocarbon radicals (R) identical or different, which can be saturated or unsaturated hydrocarbon radicals, preferably comprising from 1 to 20, particularly from 1 to 14 carbon atoms, and optionally comprising one or more silicon atoms, more particularly in organosilicon (or organosilane) radicals. The hydrocarbon radicals (R) can be chosen from aliphatic or alicyclic radicals, e.g. from alkyl, alkenyl, alkynyl, alkylidene and alkylidyne radicals preferably from C₁ to C₁₀, particularly linear or branched, or from aryl radicals preferably from C₆ to C₁₂, or from aralkyl, aralkylidene or aralkylidyne radicals preferably from C₇ to C₁₄.

The metal (M1) atom of the first metal compound (C1) can be linked to the hydrocarbon radical (R) by one or more single, double or triple carbon-metal (M1) bonds.

A single carbon-metal (M1) bond can be thus involved, in particular a bond of the 6 (sigma) type. Thus, the hydrocarbon radical (R) can be an alkyl, alkenyl or alkynyl radical, either linear or branched, or an aryl radical, e.g. a phenyl radical (C₆H₅—) or a naphthyl radical (C₁₀H₉—), or an aralkyl radical, e.g. a benzyl radical (C₆H₅—CH₂—) or an ethylbenzyl radical (C₆H₅—CH₂—CH₂—). Generally, by alkyl, alkenyl or alkynyl radical is meant a monovalent aliphatic radical arising from the removal of a hydrogen atom from a carbon atom of the molecule of respectively an alkane, an alkene or an alkyne, or even of an organosilicon (or silane) compound. The hydrocarbon radical (R) may have the general formula (R′−CH₂—) wherein R′ represents a hydrogen atom or a saturated or unsaturated aliphatic or alicyclic radical, either linear or branched. It can be selected from an alkyl radical e.g. a methyl radical (CH₃—), an ethyl radical (CH₃—CH₂—), a propyl radical (C₂H₅—CH₂—) or a neopentyl radical ((CH₃)₃C—CH₂—), an allyl radical (CH₂═CH—CH₂—), an alkenyl radical e.g. having the general formula (R′−CH═CH—) wherein R′ represents a hydrogen atom or a saturated or unsaturated aliphatic or alicyclic radical either linear or branched, an allenyl radical (CH₂═C═CH—), an alkynyl radical e.g. having the general formula (R′−C≡C—) wherein R′ represents a hydrogen atom or a saturated or unsaturated aliphatic or alicyclic radical either linear or branched, e.g. an ethynyl radical (CH≡C—), an organosilicon radical e.g. having the general formula (R′ₙSi−CH₂—) wherein R′ represents one or more different or identical saturated or unsaturated aliphatic or alicyclic radicals and/or hydrogen atoms and n is a number equal to 1, 2 or 3, e.g. a neosilyl radical ((CH₃)₃Si—CH₂—). Generally, by aralkyl radical is meant a monovalent aliphatic radical arising from the removal of a hydrogen atom from a carbon atom of an alkyl radical branched onto an aromatic molecule. Generally, by aryl radical is meant a monovalent aromatic radical arising from the removal of a hydrogen atom from a carbon atom of the ring structure of an aromatic molecule.

A double carbon-metal (M1) bond can be also involved, in particular a bond of the π (pi) type. Thus, the hydrocarbon radical (R) can be an alkylidene radical, either linear or branched, or an aralkylidene radical. Generally, by alkylidene radical is meant a divalent aliphatic radical arising from the removal of two hydrogen atoms from one and the same carbon atom of the molecule of an alkane, an alkene, or an alkyne, or even of an organosilicon (or silane) compound. The hydrocarbon radical (R) can be selected from a methylidene radical (CH₂═), an ethylidene radical (CH₃—CH═), a proplylidene radical (C₂H₅—CH═), a neopentylidene radical ((CH₃)₃C—CH═) and an allylidene radical

(CH₂═CH—CH═). It may have the general formula (R′−CH═) wherein R′ represents a hydrogen atom or an aliphatic or alicyclic radical, either linear or branched. Generally, by aralkylidene radical is meant a divalent aliphatic radical arising from the removal of two hydrogen atoms from one and the same carbon atom of an alkyl, alkenyl or alkynyl radical branched onto an aromatic molecule.

A triple carbon-metal (M1) bond can be also involved. Thus, the hydrocarbon radical (R) can be an alkylidyne radical, either linear or branched, or an aralkylidyne radical. Generally, by alkylidyne radical is meant a trivalent aliphatic radical arising from the removal of three hydrogen atoms from one and the same carbon atom of the molecule of an alkane, an alkene, or an alkyne, or even of an organosilicon (or silane) compound. The hydrocarbon radical (R) can be selected from an ethylidyne radical (CH₃—CH≡), a propylidyne radical (C₂H₅—CH≡), a neopentylidyne radical ((CH₃)₃C—CH≡) and an allylidyne radical (CH₂═CH—CH≡). It may have the general formula (R′−C≡) wherein R′ represents a hydrogen atom or an aliphatic or alicyclic radical, either linear or branched. Generally, by aralkylidyne radical is meant a trivalent aliphatic radical arising from the removal of three hydrogen atoms from one and the same carbon atom of an alkyl, alkenyl or alkynyl radical branched onto an aromatic molecule.

More particularly, the hydrocarbon radical (R) can be chosen from the methyl, ethyl, n-propyl, isopropyl, n-butyl, isobutyl, neopentyl, norbornyl, allyl, meta-allyl, neopentylidene, allylidene, neopentylidyne, mesityl, neosilyl radicals.

The first metal compound (C1) may comprise one or more ligands, such as “ancillary” ligands, preferably linked to the metal (M1). The ligand preferably comprises at least one oxygen atom and/or at least one nitrogen atom and/or at least one sulphur atom. It is particular chosen from oxo, alkoxo, aryloxo; aralkyloxo, nitrido, imido, imino, amino and amido ligands, and. Generally, by oxo, alkoxo, aryloxo, aralkyloxo, nitrido, imido, imino, amino and amido ligands are respectively meant:
a divalent oxo radical of general formula: ═O,
a monovalent alkoxo, aryloxo or aralkyloxo radical of general formula: —OR′,
a trivalent nitrido radical of general formula: ≡N,
a divalent imido radical of general formula: ═NR″,
a monovalent imino radical of general formula: —N═CH−R″,
a monovalent amino or amido radical of general formula: —NR¹R²,
   general formulae wherein O represents an oxygen atom, N represents a nitrogen atom, R′ represents an hydrogen atom or a monovalent hydrocarbon radical selected respectively from alkyl, aryl and aralkyl radicals, R″ represents a hydrogen atom or a monovalent hydrocarbon radical, and R¹ and R², being identical or different, represent a hydrogen atom or a monovalent hydrocarbon radical. More particularly, R′, R″, R¹ and R² can be a monovalent radical, either saturated or unsaturated, linear or branched, comprising from 1 to 20, preferably from 1 to 14 carbon atoms, and particularly chosen from alkyl radicals preferably from C₁ to C₁₀, aryl radicals preferably from C₆ to C₁₀ or C₁₄, and aralkyl radicals preferably from C₇ to C₁₄. Thus, in the first metal compound (C1), the metal (M1) atom can be bonded to at least one hydrogen atom and/or to at least one hydrocarbon radical (R), and in addition to at least one or more of the above-mentioned ligands, e.g. to the O atom of the oxo radical (═O) by a double bond, or to the O atom of the alkoxo, aryloxo or aralkyloxo radical (—OR′) by a single bond, or to the N atom of the nitrido radical (≡N) by a triple bond, or to the N atom of the imido radical (═NR″) by a double bond, or to the N atom of the imino radical (—N═CH—R″) by a single bond, or else to the N atom of the amino radical (—NH₂) or amido radical (—NR¹R²) by a single bond.

The solid metal compound of the present invention also comprises at least one second metal compound (C2) comprising a metal (M2) selected from the metals of Groups 8 to 10 of the Periodic Table of the Elements. The metal (M2) may be selected from iron, ruthenium, osmium, cobalt, rhodium, iridium, nickel, palladium and platinum, and preferably from iron, cobalt, nickel and platinum. The second metal compound (C2) preferably comprises a metal (M2) having a formal oxidation state selected from −4 to +8, preferably from −2 to +6, particularly from 0 to +4. More particularly, the second metal compound (C2) may comprise a metal (M2) in a reduced state.

The second metal compound (C2) can be supported on, or grafted onto the solid support comprising aluminium oxide and having a type identical to or different from that of the solid support containing the first metal compound (C1). It can be supported on, or grafted onto the same solid support particles as those containing the first metal compound

(C1), or different from those containing the first metal compound (C1), the solid support being in particular of a same type or different types.

By second metal compound (C2) grafted onto the solid support comprising aluminium oxide is generally meant an atom of the metal (M2) linked to said solid support, preferably by one or more single bonds, particularly to at least one oxygen atom of the aluminium oxide, e.g. according to the general formula: (M2−OAl) or (AlO−M2−OAl). The atom of the metal (M2) can be linked to an oxygen atom of the aluininium oxide already linked by another oxygen atom to the metal (M1) atom of the first metal compound (C1), e.g. according to the general formula: (M2−OAlO−M1).

More particularly, the second metal compound (C2) can be selected from metal hydrides, organometallic compounds and organometallic hydrides, in particular supported on, preferably grafted onto the solid support.

By second metal compound (C2) selected from metal hydrides is generally meant an atom of the metal (M2) linked to one or more hydrogen atoms by a single bond e.g. according to the general formula (M2−H). The number of hydrogen atoms linked to a metal (M2) atom can depend on the formal oxidation state of said metal (M2) and optionally on the number of single bonds linking said metal (M2) atom to the solid support, particularly to oxygen atom of the aluminium oxide e.g. according to the general formula (M2−OAl), when the second metal compound (C2) is particularly grafted onto the solid support.

By second metal compound (C2) selected from organometallic compounds is generally meant an atom of the metal (M2) linked to one or more hydrocarbon radicals (R) identical or different, particularly by single or multiple carbon-metal (M2) bonds, e.g. a single bond (M2—R), a double bond (M2═R) or a triple bond (M2≡R). The number of the hydrocarbon radicals (R) linked to a metal (M2) atom can depend on the formal oxidation state of said metal (M2), on the type of the single or multiple carbon-metal (M2) bonds, and optionally on the number of single bonds linking said metal (M2) atom to the solid support, particularly to oxygen atom of the aluminium oxide e.g. according to the general formula (M2−OAl), when the second metal compound (C2) is particularly grafted onto the solid support.

By second metal compound (C2) selected from organometallic hydrides is generally meant an atom of the metal (M2) simultaneously linked to one or more hydrocarbon radicals (R) identical or different, particularly by single or multiple carbon-metal (M2) bonds, e.g. a single bond (M2—R), a double bond (M2═R) or a triple bond (M2≡R), and to one or more hydrogen atoms by a single bond e.g. according to the general formula (M2−H). The total number of the hydrocarbon radicals (R) and of the hydrogen atoms linked to a metal (M2) atom can depend on the formal oxidation state of said metal (M2), on the type of the single or multiple carbon-metal (M2) bonds, and optionally on the number of single bonds linking said metal (M2) atom to the solid support, particularly to oxygen atom of the aluminium oxide e.g. according to the general formula (M2−OAl), when the second metal compound (C2) is particularly grafted onto the solid support.

The second metal compound (C2) can be selected from the organometallic compounds and the organometallic hydrides, comprising one or more hydrocarbon radicals (R) identical or different, and having the same definition as for the hydrocarbon radicals (R) as previously defined for the first metal compound (C1).

The second metal compound (C2) may comprise one or more ligands, such as “ancillary” ligands, as previously defined for the first metal compound (C1), and preferably linked to the metal (M2). The ligand of the second metal compound (C2) may be identical or different from that of the first metal compound (C1). In particular, it comprises at least one oxygen atom and/or at least one nitrogen atom and/or at least one sulphur atom. Preferably, the ligand can be selected from sulphate, sulphite, nitrate, acetylacetonate, oxo, alkoxo, aryloxo, aralkyloxo, nitrido, imido, imino, amino and amido ligands. Thus, in the second metal compound (C2), the metal (M2) atom can be linked to at least one or more of the above-mentioned ligands, e.g. to the O atom of the oxo radical (═O) by a double bond, or to the O atom of the alkoxo, aryloxo or aralkyloxo radical (—OR′) by a single bond, or to the N atom of the nitrido radical (≡N) by a triple bond, or to the N atom of the imido radical (═NR″) by a double bond, or to the N atom of the imino radical (—N═CH—R″) by a single bond, or else to the N atom of the amino radical (—NH₂) or amido radical (—NR¹R²) by a single bond.

The second metal compound (C2) can be also selected from the above-mentioned metal hydrides, organometallic compounds and organometallic hydrides, comprising in addition one or more of the above-mentioned ligands, particularly the “ancillary” ligands, and preferably linked to the metal (M2).

The second metal compound (C2) can be a metal selected from the metals (M2) with a formal oxidation state equal to 0, and thus can be present in the form of metal (M2) particles. In this case, the second metal compound (C2) is preferably supported on the solid support.

In the solid metal compound, the weight percentage of the metal (M1) can be selected from 0.1 to 15%, preferably from 0.5 to 10%. The weight percentage of the metal (M2) in the solid metal compound can be selected from 0.1 to 15%, preferably from 0.5 to 10%. In the solid metal compound, the molar ratio of the metal (M1) to the metal (M2) (i.e. the molar ratio (M1):(M2)) can be selected from 1:100 to 100:1, preferably from 1:16 to 16:1,particularly from 1:10 to 10:1, especially from 1:5 to 5:1. In some cases, it can be selected from 1:100 to 1:1, preferably from 1:50 to 1:1, particularly from 1:30 to 1:1, especially from 1:20 to 1:1. In other cases, it can be selected from 1:1 to 100:1, preferably from 1:1 to 50:1, particularly from 1:1 to 30:1, especially from 1:1 to 20:1.

The solid metal compound preferably comprises a combination of metals (M1) and (M2) selected from tungSten and nickel, tungsten and platinum, tantalum and cobalt, and rhenium and iron.

The present invention also relates to processes for preparing the above-mentioned solid metal compound.

A process for preparing the solid metal compound can comprise generally:
stage (1) comprising dispersing and preferably grafting (i) an organometallic precursor (Pr1) comprising the metal (M1) linked to at least one hydrocarbon radical (R) and (ii) a precursor (Pr2) comprising the metal (M2) onto the solid support comprising aluminium oxide, either simultaneously or separately, in particular successively in a given order or in a reverse order, so as to produce the solid metal compound, and preferably
stage (2) compiising contacting the solid metal compound obtained in stage (1) with hydrogen and/or a reducing agent.

Prior to stage (1), the solid support can be preferably subjected to a preliminary stage comprising calcination and/or dehydroxylation of the solid support. Generally, the calcination of the solid support comprises oxidising any carbon present in the support and removing said carbon in the form of carbon dioxide. More particularly, the calcination can be carried out by subjecting the support to an oxidising thermal treatment, preferably in an atmosphere or a current of air, particularly dry air, particularly at a temperature below the fritting temperature of the support, e.g. at a temperature selected from 100 to 1000° C., preferably from 200 to 800° C. The calcination generally can be carried out under an absolute pressure selected in a broad range, e.g. under a sub-atmospheric pressure, preferably selected from 10⁻⁴ Pa to less than 10² kPa, or from 10⁻² Pa to 50 kPa, or the atmospheric pressure, or a supra-atmospheric pressure preferably higher than 10² kPa and lower than 10 MPa. The calcination can be generally carried out for a time sufficient to allow the carbon dioxide to be removed from the support, e.g. a time selected from 10 minutes to 100 hours, preferably from 20 minutes to 48 hours.

Prior to stage (1), the solid support can be also subjected to a preliminary stage comprising dehydroxylation. Generally, the dehydroxylation of the solid support comprises removing any residual water from the support and at least partially hydroxyl groups of support so as to allow a residual quantity of the hydroxyl groups to remain in the support, more particularly at the surface of the support, and/or to produce aluminoxane groups (generally having the formula: Al−O−Al) in the support. More particularly, the dehydroxylation can be carried out by subjecting the support to a thermal treatment generally at a temperature below the fritting temperature of the support, e.g. at a temperature selected from 100 to 1000° C., preferably from 200 to 800° C. The dehydroxylation can be carried out in an inert atmosphere or an inert gas current, preferably in the presence of an inert gas e.g. selected from nitrogen, argon and helium. The dehydroxylation can be also carried out under a sub-atmospheric pressure, e.g. at an absolute pressure selected from 10⁻⁴ Pa to less than 10² kPa, preferably from 10⁻² Pa to 50 kPa. The dehydroxylation is preferably carried out for a time generally sufficient to allow residual quantities of hydroxyl groups to remain in the support and/or aluminoxane groups to be produced in the support, so that said hydroxyl and/or aluminoxane groups are preferably able to react and/or to complex further with the precursors during the preparation of the solid compound. Generally, the dehydroxylation can be carried out for a time selected from 10 minutes to 100 hours, preferably from 20 minutes to 48 hours. Preferably, the preliminary stage comprises first the calcination of the solid support and then the dehydroxylation of the solid support thus calcined.

The organometallic precursor (Pr1) generally comprises the metal (M1) linked to one or more hydrocarbon radicals (R) and optionally to at least one hydrogen atom. The metal (M1) atom can be linked to a carbon of the hydrocarbon radical (R) by single, double or triple carbon-metal (M1) bonds. The hydrocarbon radicals (R) can be hydrocarbon radicals, identical or different, saturated or unsaturated, preferably comprising from 1 to 20, particularly from 1 to 14 carbon atoms, and optionally one or more silicon atoms, and can be chosen from the hydrocarbon radicals (R) previously described. They can be particularly selected from aliphatic or alicyclic radicals, e.g. from alkyl, alkenyl, alkynyl, alkylidene or alkylidyne radicals, linear or branched, in particular from C₁ to C₁₀, or from aryl radicals, in particular from C₆ to C₁₂, or from aralkyl, aralkylidene or aralkylidyne radicals, in particular from C₇ to C₁₄. The number of hydrocarbon radicals (R) and optionally of hydrogen atoms linked to the metal (M1) atom depends generally on the formal oxidation state of the metal (M1) in the organometallic precursor (Pr1).

The precursor (Pr2) can be selected from organometallic precursors comprising the metal (M2) linked to one or more hydrocarbon radicals (R) and optionally to at least one hydrogen atom. The metal(s) (M2) can be identical or different, saturated or unsaturated, preferably comprising from 1 to 20, particularly from 1 to 14 carbon atoms, and optionally comprising one or more silicon atoms, said hydrocarbon radicals (R) being identical to or different from those of the organometallic precursor (Pr1). The hydrocarbon radicals (R) of the precursor (Pr2) generally have same general definitions as those previously given for the hydrocarbon radicals (R) of the organometallic precursor (Pr1).

The precursor (Pr2) can be also selected from metal (M2) salts, preferably from organic metal (M2) salts and inorganic metal (M2) salts, in particular metal (M2) salts which are soluble in water so that the precursor (Pr2) can be preferably used in the form of an aqueous solution of the metal (M2) salts in the process for preparing the solid metal compound. More particularly, the precursor (Pr2) can be a metal (M2) salt selected from metal (M2) sulphates, sulphites, nitrates, nitrites, phosphates, phosphites, borates, fluorides, chlorides, bromides, iodides, alcoholates, carboxylates, oxalates, acetates, glycolates and acetylacetonates.

In stage (1), the precursors (Pr1) and (Pr2) can be dispersed and preferably grafted onto the solid support, either together onto the same solid support particles, or separately onto different solid support, particles, the solid support being of the same type or of different types.

In stage (1), dispersing and preferably grafting the precursors (Pr1) and (Pr2) onto the solid support can be carried out by various methods, in particular by a method selected from sublimation, impregnation and dry mixing. Dispersing and preferably grafting the precursors can be monitored during the preparation of the solid metal compound by various methods, e.g. by infrared spectroscopy.

Dispersing and preferably grafting the precursors can be carried out by sublimation. Preferably the sublimation comprises involving the precursors in the solid state generally under standard conditions and heating said precursors in the presence of the solid support at a temperature allowing the precursors to sublime and to migrate in the gaseous state onto the solid support, and preferably to react with said support. The sublimation can be carried out at a temperature selected from −30 to 300° C., preferably from −30 to 200° C., particularly from 20 to 150° C., but lower than the temperature of decomposition of the precursors. The sublimation can be also carried out in an inert atmosphere, preferably in the presence of an inert gas e.g. selected from nitrogen, argon and helium, and particularly under a sub-atmospheric pressure, preferably an absolute pressure selected from 10⁻⁴ Pa to less than 10² kPa, particularly from 10⁻⁴ to 1 Pa. Any excess of the precursor which cannot be dispersed and preferably grafted onto the solid support, can be removed by inverse sublimation.

Dispersing and preferably grafting the precursors can be also carried out by impregnation preferably with the help of a liquid or a solvent. Preferably the impregnation comprises placing the precursors either in suspension in a liquid, or preferably in solution in a solvent, e.g. in an aqueous solution or in an organic solvent either polar or non-polar, e.g. pentane or ethyl ether, and contacting the solid support with said suspension or said solution, preferably with stirring. The impregnation can be carried out at a temperature selected in a broad range, but lower than the temperature of decomposition of the precursors, e.g. a temperature selected from −80 to 300° C., preferably from −80° C. to 200° C., particularly from 20 to 150° C. The impregnation can be also carried out in an inert atmosphere, preferably in the presence of an inert gas e.g. selected from nitrogen, argon and helium, and under an absolute pressure selected in a broad range, e.g. a sub-atmospheric pressure, the atmospheric pressure or supra-atmospheric pressure. The impregnation generally results in the formation of a suspension of the solid metal compound according to the invention, from which the liquid or the solvent can be removed. Any excess of the precursors which cannot be dispersed and preferably grafted onto the solid support, can be removed by washing with a liquid or a solvent identical to or different from that used for the impregnation.

Dispersing and preferably grafting the precursors can be also carried out by dry mixing, preferably with stirring and particularly with the help of a mechanical mixer. By dry mixing is generally meant a mixing carried out in the absence of liquid or solvent. The dry mixing can comprise involving the precursors in the solid state generally under standard conditions and mixing said precursors with the solid support, in the absence of liquid or solvent, preferably with stirring. The dry mixing can be carried out in an inert atmosphere, preferably in the presence of an inert gas e.g. selected from nitrogen, argon and helium: During or. after the dry mixing, a thermal and/or sub-atmospheric treatment can be carried out so as to allow the precursors to migrate onto the solid support and preferably to react with said support. The treatment can be carried out at a temperature selected in a broad range, preferably selected from −30 to 300° C., preferably from −30 to 200° C., particularly from 20 to 150° C. It can be also carried out in an inert atmosphere, preferably in the presence of an inert gas e.g. selected from nitrogen, argon and helium, and preferably under a sub-atmospheric pressure, e.g. under an absolute pressure selected from 10⁻⁴ Pa to less than 10² kPa. Any excess of the precursors which cannot be dispersed or preferably grafted onto the solid support, can be removed by inverse sublimation or by washing with a liquid, preferably an inert organic liquid.

Preferably, stage (1) comprises both (i) dispersing the organometallic precursor (Pr1) and the precursor (Pr2) and (ii) grafting said organometallic precursor (Pr1) and optionally said precursor (Pr2) onto the solid support. More particularly, grafting can be carried out with the solid support previously subjected to the above-described preliminary stage preferably comprising the dehydroxylation of the support. Thus, the dehydroxylation of the support advantageously allows residual quantities of hydroxyl groups to remain in the support and/or aluminoxane groups to be produced in the support, so that said hydroxyl and/or aluminoxane groups can further react and/or complex with the organometallic precursor (Pr1) and optionally the precursor (Pr2), and thus lead to the grafting.

The preparation of the solid metal compound preferably comprises stage (2) wherein the solid metal compound obtained in stage (1) is preferably contacted with hydrogen and/or a reducing agent. The contacting is preferably carried out so as to produce hydrogenolysis and/or reduction of the first metal compound (C1) comprising the metal (M1) and of the second metal compound (C2) comprising the metal (M2), dispersed and preferably grafted onto the solid support. By hydrogenolysis is generally meant a reaction producing splitting of a molecule into two portions and fixing of hydrogen onto the two split portions. In the present case, the hydrogenolysis generally involves a splitting reaction occurring between the metal (M1) and/or (M2) atom and the carbon atom of the hydrocarbon radicals of the first and second metal compounds (C1) and (C2). It generally results from the contacting, the production of the first metal compound (C1) and optionally the second metal compound (C2), respectively comprising either metal (M1) hydrides or organometallic (M1) hydrides, and optionally either (M2) hydrides or organometallic (M2) hydrides, dispersed and preferably grafted onto the solid support. Thus, during the hydrogenolysis, the first metal compound (C1) can be produced for example according to the following equations (2) to (5):

M1-R+H₂→M1-H+R—H (2)

(R)M1-R+H₂→(R)M1-H+R—H (3)

Al—O-M1-R+H₂→Al—O-M1-H+R—H (4)

Al—O—(R)M1-R+H₂→Al—O—(R)M1-H+R—H (5)

wherein M1 represents the metal (M1), R represents an hydrocarbon radical as previously described, H represents an hydrogen atom, H₂ represents the molecule of hydrogen, Al represents an aluminium atom and O represents an oxygen atom. More particularly, equation (2) represents the hydrogenolysis of an organometallic (M1) compound comprising one hydrocarbon radical (R) leading to the production of a metal (M1) hydride dispersed onto the solid support (not represented in equation (1)). Equation (3) represents the hydrogenolysis of an organometallic (M1) compound comprising two hydrocarbon radicals (R) leading to the production of an organometallic (M1) hydride dispersed onto the solid support (not represented in equation (2)). Equation (4) represents the hydrogenolysis of an oganometallic (M1) compound comprising one hydrocarbon radical (R) and grafted onto the solid support (based on aluminium oxide) leading to the production of a metal (M1) hydride grafted onto said solid support. Equation (5) represents the hydrogenolysis of an organometallic (M1) compound comprising two hydrocarbon radicals (R) and grafted onto the solid support (based on aluminium oxide) leading to the production of an organometallic (M1) hydride grafted onto said solid support.

In a similar way, the second metal compound (C2) can be produced during the hydrogenolysis for example according to the following equations (6) to (9):

M2-R+H₂→M2-H+R—H (6)

(R)M2-R+H₂→(R)M2-H+R—H (7)

Al—O-M2-R+H₂→Al—O-M2-H+R—H (8)

Al—O—(R)M2-R+H₂→Al—O—(R)M2-H+R—H (9)

wherein M2 represents the metal (M2) and the other symbols have the same meanings as in the equations (2) to (5). Equation (6) represents the hydrogenolysis of an organometallic (M2) compound comprising one hydrocarbon radical (R) leading to the production of a metal (M2) hydride dispersed onto the solid support (not represented in equation (6)). Equation (7) represents the hydrogenolysis of an organometallic (M2) compound comprising two hydrocarbon radicals (R) leading to the production of an organometallic (M2) hydride dispersed onto the solid support (not represented in equation (7)). Equation (8) represents the hydrogenolysis of an organometallic (M2) compound comprising one hydrocarbon radical (R) and grafted onto the solid support (based on aluminium oxide) leading to the production of a metal (M2) hydride grafted onto said solid support. Equation (9) represents the hydrogenolysis of an organometallic (M2) compound comprising two hydrocarbon radicals (R) and grafted onto the solid support (based on aluminium oxide) leading to the production of an organometallic (M2) hydride grafted onto said solid support.

Generally, it results from stage (2) the production of the first metal compound (C1) and/or the second metal compound (C2) respectively comprising the metals (M1) and (M2) which can be at least partially in a reduced state.

Stage (2) can be carried out in the presence of a hydrogen atmosphere, e.g. under a hydrogen partial pressure selected from 1 kPa to 10 MPa, or a combination of hydrogen with an inert gas, or else in the presence of an inert atmosphere when a reducing agent is used, preferably under an absolute pressure selected from 10⁻² to 10 MPa, in particular at a temperature selected from 20 to 500° C., preferably from 20 to 250° C., and more particularly for a time of contacting selected from 10 minutes to 48 hours, preferably from 20 minutes to 24 hours.

The reducing agent used in stage (2) can be selected from hydrogen and particularly from hydrides, preferably hydrides having a metal or an element selected from Groups 13 and 14 of the Periodic Table of the Elements, e.g. selected from aluminium hydrides, boron hydrides, tin hydrides and silanes.

Various methods can be carried out for preparing the solid metal compound of the invention, particularly when both the precursors (Pr1) and (Pr2) are selected from organometallic precursors comprising one or more hydrocarbon radicals (R) identical or different, saturated or unsaturated, and respectively linked to the metals (M1) and (M2), and optionally to at least one hydrogen atom. Thus, for example, the process for preparing the solid metal compound may comprise:
stage (1) comprising dispersing and preferably grafting, either simultaneously or separately, in particular successively in a given order or in a reverse order, the organometallic precursor (Pr1) and the precursor (Pr2) onto the solid support, said precursor (Pr2) being selected from the organometallic precursors comprising the metal (M2) preferably linked to one or more hydrocarbon radicals (R) identical or different, saturated or unsaturated, and optionally to at least one hydrogen atoms, so as to produce the solid metal compound preferably comprising metal (M1)/(M2) hydrocarbon compounds supported on, or grafted onto said support, and preferably
stage (2) comprising contacting the solid metal compound obtained in stage (1) with hydrogen and/or a reducing agent.

The solid metal compound thus obtained after stage (1) may generally comprise organometallic (M1)/(M2) compounds supported on, or grafted onto the solid support. The solid metal compound obtained after stages (1) and (2) may generally comprise metal (M1)/(M2) hydrides and optionally organometallic (M1)/(M2) hydrides supported on, or grafted onto the solid support.

Various methods can be also carried out for preparing the solid metal compound of the invention, particularly when the precursor (Pr1) is selected from the above-mentioned organometallic precursors, preferably comprising one or more hydrocarbon radicals (R) identical or different and linked to the metal (M1), while the precursor (Pr2) is selected from the above-mentioned metal (M2) salts, preferably metal (M2) inorganic salts, in particular water soluble metal (M2) inorganic salts. Thus, the process for preparing the solid metal compound may comprise:
stage (a) comprising impregnating the solid support with an aqueous solution of the precursor (Pr2) selected from metal (M2) salts,
stage (b) comprising drying and subjecting to calcination and/or preferably to dehydroxylation the solid product obtained in stage (a),
stage (c) comprising reducing the metal (M2) by contacting the solid product obtained in stage (b) with hydrogen and/or a reducing agent,
optionally stage (d) comprising desorbing hydrogen from the solid product obtained in stage (c) when hydrogen is used,
stage (e) comprising dispersing and preferably grafting the organometallic precursor (Pr1) onto the solid product obtained in stage (c) or (d), so as to produce the solid metal compound, and preferably
stage (f) comprising contacting the solid metal compound obtained in stage (e) with hydrogen, so as to subject the organometallic (M1) compound dispersed and preferably grafted onto the solid support preferably to hydrogenolysis.

Another method can also be carried out for preparing the solid metal compound of the invention. The process for preparing the solid metal compound may comprise:
stage (i) comprising preparing the first metal compound (C1),
stage (ii) comprising preparing the second metal compound (C2), and
stage (iii) comprising mixing the first and second metal compounds (C1) and (C2), so as to produce the solid metal compound according to the invention.

The first and second metal compounds (C1) and (C2) can be separately prepared according to one of the above-mentioned processes. The mixing of the first and second metal compounds (C1) and (C2) can be carried out according to various methods, for instance by adding the first metal compound (C1) to the second metal compound (C2), or by adding the second metal compound (C2) to the first metal compound (C1), or else by simultaneously adding the first and the second metal compounds (C1) and (C2), e.g. into a mixing zone preferably comprising stirring means and under an inert atmosphere. The mixing can be carried out in the presence of a liquid, particularly in an inert liquid suspension zone, or in the absence of a liquid, particularly in a dry mixing zone.

The present invention also relates to a process for reactivating or regenerating the solid metal compound previously described, preferably after or during the use of said solid metal compound. The process can comprise contacting the solid metal compound with hydrogen or any compound capable of forming hydrogen “in situ”. Hydrogen can be used alone, e.g. in a pure state, or mixed with an inert gas, e.g. nitrogen, argon or helium. The contacting can be carried out under a hydrogen absolute pressure selected from 0.01 MPa to 10 MPa, preferably from 0.1 to 2 MPa. It can be also carried out at a temperature selected from 50 to 500° C., preferably from 60 to 400° C., particularly from 70 to 350° C., especially from 80 to 300° C. The contacting can be also carried out during the use of the solid metal compound, e.g. in a process involving hydrocarbon reactions, such as the reactions subsequently described, or after and separately from said use.

The present invention further relates to the use of the solid metal compound previously described, essentially as a catalyst, in a process involving hydrocarbon reactions, preferably comprising contacting said solid metal compound with one or more starting hydrocarbons optionally in the presence of hydrogen, and involving the splitting and recombining of carbon-carbon and/or carbon-hydrogen and/or carbon-metal bonds, so as to produce final hydrocarbon(s) different from the starting hydrocarbons.

More particularly, the present invention relates to the use of the solid metal compound, essentially as a catalyst, in a process for manufacturing saturated or unsaturated hydrocarbon(s) having a modified carbon skeleton. The process preferably comprises contacting at least one saturated or unsaturated aliphatic hydrocarbon with itself, or with at least one other saturated or unsaturated aliphatic hydrocarbon, or with at least one aromatic hydrocarbon substituted by at least one hydrocarbon radical, or else with at least one saturated or unsaturated alicyclic hydrocarbon substituted by at least one hydrocarbon radical, e.g. an alkyl, alkenyl or alkynyl radical, in the presence of said solid metal compound and optionally of hydrogen. The hydrocarbons used in these processes can be saturated or unsaturated hydrocarbons, preferably selected from alkanes and alkenes (olefins). More particularly, the hydrocarbons involved in these processes can be chosen from:
linear aliphatic saturated or unsaturated hydrocarbons, in particular from C₂ to C₃₀, preferably from C₂ to C₂₀,
branched aliphatic saturated or unsaturated hydrocarbons, in particular from C₄ to C₃₀, preferably from C₄ to C₂₀, especially having an “iso” structure,
aromatic hydrocarbons substituted by at least one hydrocarbon radical and particularly selected from C₇ to C₃₀, preferably from C₇ to C₂₀, said hydrocarbon radical preferably being linear or branched and selected from C₁ to C₂₄, preferably from C₁ to C₁₄,
alicyclic saturated or unsaturated hydrocarbons substituted by at least one hydrocarbon radical and particularly selected from C₄ to C₃₀, preferably from C₄ to C₂₀, said hydrocarbon radical preferably being linear or branched and selected from C₁ to C₂₇, preferably from C₁ to C₁₇.

More particularly, the solid metal compound can be used, essentially as a catalyst, in a process comprising alkane metathesis reactions, preferably metathesis reactions of an alkane with itself, i.e. alkane self-metathesis reactions, or metathesis reactions of an alkane with at least one other alkane, i.e. alkane cross-metathesis reactions. In particular, the alkane(s) can be either linear or preferably branched especially with an “iso” structure, and selected from the C₂ to C₁₀ alkanes, particularly from ethane, propane, n-butane, isobutane, n-pentane, isopentane, neopentane, n-hexane, isohexane, neohexane, n-heptane, isoheptane, neoheptane, n-octane, isooctane, neooctane, n-nonane, isononane, neononane, n-decane, isodecane and neodecane. The solid metal can be also used in a specific process converting isobutane into 2,3-dimethylbutane. Generally these processes can be carried out at a temperature selected from 20 to 500° C., preferably from 50 to 400° C., particularly from 50 to 350° C., under an absolute pressure particularly selected from 0.1 to 100 MPa, preferably from 0.1 to 50 MPa. The solid metal compound can be particularly used in the processes as described in International Patent Application WO 98/02244.

The solid metal compound can be also used, essentially as a catalyst, in a process comprising alkene (olefin) metathesis reactions, preferably metathesis reactions of an alkene with itself, i.e. alkene self-metathesis reactions, or metathesis reactions of an alkene with at least one other alkene, i.e. alkene cross-metathesis reactions, the alkene(s) being preferably linear or branched especially with an “iso” structure, and selected from the C₂ to C₁₀ alkenes, e.g. from α-olefins (alpha-olefins), particularly from ethylene, propylene, 1-butene, isobutene, trans-2-butene, cis-2-butene, 1-pentene, 2-pentene, isopentene, 1-hexene, 2-hexene, 3-hexene, isohexene, neohexene, 1-heptene, 2-heptene, 3-heptene, isoheptene, neoheptene, 1-octene, 2-octene, 3-octene, 4-octene, isooctene, neooctene, 1-nonene, 2-nonene, 3-nonene, 4-nonene, isononene, neononene, 1-decene, 2-decene, 3-decene, 4-decene, 5-decene, neodecene and isodecene. The solid metal compound can be used in a specific process converting ethylene into propylene as described in International Patent Application WO 2006/013251, or in a process comprising alkene (olefin) metathesis reactions as described in International Patent Application WO 2006/013263. It can be also used in a specific process converting isobutene into neohexene (i.e. 3,3-dimethyl-1-butene).

The solid metal compound can be also used, essentially as a catalyst, in a process comprising alkene (olefin) oligomerisation, preferably ethylene or propylene oligomerisation.

The solid metal compound can be also used, essentially as a catalyst, in a process comprising a non-oxidative coupling reaction of methane, preferably for producing ethane. The process can be carried out at a temperature selected from 20 to 500° C., preferably from 50 to 400° C., particularly from 70 to 350° C., and preferably under an absolute pressure selected from 0.01 to 100 MPa, preferably from 0.1 to 50 MPa. The solid metal compound can be particularly used in the process as described in International Patent Application WO 03/104171.

The solid metal compound can be also used, essentially as a catalyst, in a process comprising a methane-olysis reaction preferably carried out by contacting methane with at least one other aliphatic hydrocarbon, or with at least one aromatic or alicyclic hydrocarbon substituted by at least one hydrocarbon radical. More particularly, the process can comprise contacting, in the presence of the solid metal compound, methane with:
at least one other aliphatic hydrocarbon chosen from linear aliphatic hydrocarbons particularly from C₂ to C₃₀, preferably from C₃ to C₂₀, and from branched aliphatic hydrocarbons particularly from C₄ to C₃₀, preferably from C₄ to C₂₀, especially having an “iso” structure, or
at least one aromatic hydrocarbon substituted by at least one hydrocarbon radical and particularly selected from C₇ to C₃₀, preferably from C₇ to C₂₀, said hydrocarbon radical preferably being linear or branched, saturated or unsaturated, in particular from C₁ to C₂₄, preferably from C₁ to C₁₄, e.g. an alkyl, alkenyl or alkynyl radical, or
at least one alicyclic hydrocarbon substituted by at least one hydrocarbon radical and particularly selected from C₄ to C₃₀, preferably from C₄ to C₂₀, said hydrocarbon radical preferably being linear or branched, saturated or unsaturated, in particular from C₁ to C₂₇, preferably from C₁ to C₁₇, e.g. an alkyl, alkenyl or alkynyl radical.

The solid metal compound can be also used in a process comprising methane-olysis reactions preferably carried out by contacting methane with natural gas, liquefied petroleum gas or LPG, wet gas or wet natural gas (i.e. a mixture of methane with alkanes of C₂ to C₅, or C₃ and/or C₄), natural-gas liquid or NGL, or cuts of light hydrocarbons preferably selected from cuts from C₁ to C₆, from C₁ to C₅, from C₁ to C₄, from C₁ to C₃, and from C₁ to C₂.

The solid metal compound can be used in such processes comprising a methane-olysis reaction generally carried out at a temperature selected from 20 to 500° C., preferably from 50 to 400° C., particularly from 70 to 350° C., and preferably at a methane partial pressure selected from 0.1 to 100 MPa, particularly from 0.1 to 50 MPa. The solid metal compound can be particularly used in the methane-olysis processes as described in International Patent Applications WO 01/004077 and WO 03/066552.

The solid metal compound can be also used in a process comprising a cross-metathesis reaction between said solid metal compound and at least one starting hydrocarbon preferably selected from:
linear or branched aliphatic hydrocarbons, in particular from C₂ to C₃₀, preferably from C₂ to C₂₀, especially having an “iso” structure, or
alicyclic hydrocarbons substituted by at least one hydrocarbon radical and particularly selected from C₄ to C₃₀, preferably from C₄ to C₂₀, said hydrocarbon radical being linear or branched, in particular from C₁ to C₂₇, preferably from C₁ to C₁₇, e.g. an alkyl, alkenyl or alkynyl radical.

The solid metal compound can be used in such a cross-metathesis process carried out at a temperature selected from 20 to 500° C., preferably from 50 to 400° C., especially from 70 to 350° C., and preferably under an absolute pressure selected from 0.01 to 50 MPa, preferably from 50 to 20 MPa. It can be particularly used in a cross-metathesis process as described in International Patent Application WO 00/027781.

The solid metal compound can be also used in a process comprising a hydrocarbon hydrogenolysis reaction. Generally, a hydrogenolysis reaction comprises contacting at least one starting hydrocarbon with hydrogen in the presence of the solid metal compound, so as to produce at least one final hydrocarbon having a carbon skeleton modified. The starting hydrocarbon can be selected (i) from saturated hydrocarbons, e.g. the above-mentioned alkanes, (ii) from hydrocarbon polymers or oligomers, e.g. (co)polymers or (co)oligomers of one or more olefinic or vinyl monomers, in particular polyolefins, preferably polyethylene, polypropylene, poly-1-butene, polyisobutene, copolymers of ethylene with at least one alpha-olefin from C₃ to C₈, copolymers of propylene with at least one alpha-olefin from C₄ to C₈, and copolymers of isobutene with 1-butene, or aromatic polyvinyl, preferably polystyrene or polyalphamethylstyrene, or (iii) from hydrocarbon waxes, e.g. Fisher-Tropsch waxes, polyethylene waxes and polypropylene waxes. Generally, such processes can be carried out at a temperature selected from 20 to less than 400° C., preferably from 50 to 300° C., preferably under a hydrogen partial pressure selected from 10⁻³ to 20 MPa, preferably from 10⁻² to 10 MPa, in particular for a time selected from 5 minutes to 100 hours, preferably from 10 minutes to 50 hours. The solid metal compound can be particularly used in the process as described in European Patent Application EP 0 840 771.

The following examples illustrate the present invention.

### EXAMPLE 1

### Preparation of a Solid Metal Compound (W, Ni/Al-1) Comprising Tungsten and Nickel Compounds and an Aluminium Oxide Support

In a first stage, there were introduced into a glass reactor with stirring at 25° C., 1 g of a γ-alumina (gamma-alumina) used as a solid support having a mean particle size of 40 μm and a specific surface area (B.E.T.) of 200 m²/g, containing 90 wt % of alumina and 9 wt % of water, and sold by Degussa (Germany), and 5 ml of an aqueous solution containing 46 mg of nickel sulphate hexahydrate (NiSO₄, 6H₂O) used as a precursor (Pr2). The mixture thus obtained was maintained under stirring at 25° C. for 1 hour. At the end of this time, a water suspension of the alumina support impregnated with nickel sulphate was obtained.

In a second stage, the nickel impregnated alumina support thus obtained was separated from water, and subjected to a treatment comprising drying and calcination, carried out in a dry air current at 500° C. for 3 hours, so as to obtain a nickel compound supported on the alumina support.

In a third stage, the nickel compound supported on the alumina support thus dried and calcined was then subjected to a reduction treatment carried out by subjecting said nickel compound to a current of hydrogen in a continuous flow reactor at 390° C. under a hydrogen absolute pressure of 10² kPa for 20 hours. At the end of this time, a reduced nickel compound supported on the alumina support was obtained and then subjected to a hydrogen desorption carried out under vacuum at 500° C. for 2 hours.

In a fourth stage, there were introduced into a glass reactor under an argon atmosphere and at 25° C., 900 mg of the nickel compound previously obtained, followed by a n-pentane solution containing 150 mg of tungsten tris(neopentyl) neopentylidyne used as an organometallic precursor (Pr1) having the general formula (10):

W[—CH₂—C(CH₃)₃]₃[≡C—C(CH₃)₃] (10)

The mixture thus obtained was kept at 25° C. for 3 hours. At the end of this time, an organometallic tungsten compound supported on and grafted onto the alumina support containing the nickel compound was obtained. The excess of the organometallic precursor (Pr1) which had not reacted, was removed by washing with n-pentane at 25° C. The organometallic tungsten compound thus supported on and grafted onto the alumina support containing the nickel compound was then dried under vacuum.

In a fifth stage, 600 mg of the organometallic tungsten compound supported on and grafted on the alumina support containing the nickel compound as previously obtained were isolated in a glass reactor and subjected to a hydrogenolysis treatment by contacting with hydrogen under a hydrogen absolute pressure of 73 kPa at 150° C. for 15 hours. At the end of this time, the reactor was cooled to 25° C. and there was obtained and isolated under an argon atmosphere a solid metal compound (W, Ni/Al-1) according to the invention, comprising an organometallic tungsten hydride (C1) and a nickel compound (C2) supported on and grafted onto the alumina support, and containing 3.7 wt % of tungsten and 1 wt % of nickel.

### EXAMPLE 2

### Preparation of a Solid Metal Compound (W, Ni/Al-2) Ccomprising Tungsten and Nickel Compounds and an Aluminium Oxide Support

In a preliminary stage, 1 g of the γ-alumina (gamma-alumina) identical to that used in Example 1 as a support was subjected to a calcination treatment carried out by contacting said alumina with a current of dry air at 500° C. for 15 hours, and then to a dehydroxylation treatment carried out by subjecting the alumina thus calcined to a vacuum treatment under an absolute pressure of 10⁻² Pa at 500° C. for 15 hours.

In a first stage, there were introduced into a glass reactor under an argon atmosphere at 25° C., the alumina support previously obtained and simultaneously:
a n-pentane solution containing 150 mg of tungsten tris(neopentyl) neopentylidyne used as an organometallic precursor (Pr1) having the general formula (11):

W[—CH₂—C(CH₃)₃]₃[≡C—C(CH₃)₃] (11)
(ii) and a n-pentane solution containing 30 mg of nickel bis(meta-allyl) used as a precursor (Pr2) having the general formula (12):

Ni[η³CH₂—C(CH₃)═CH₂]₂ (12)

The mixture thus obtained was kept at 25° C. for 3 hours. At the end of this time, organometallic W/Ni compounds supported on and grafted onto the alumina support were obtained. The excess of the precursors (Pr1) and (Pr2) which had not reacted, was removed from the organometallic W/Ni compounds supported on and grafted onto the alumina support by washing with n-pentane at 25° C. The organometallic W/Ni compounds thus supported and grafted were dried under vacuum, and contained 3.6 wt % of tungsten and 0.9 wt % of nickel.

In a second stage, 600 mg of the organometallic W/Ni compounds supported on and grafted onto the alumina support as previously obtained, were isolated in a glass reactor and subjected to a hydrogenolysis treatment carried out by contacting said W/Ni compounds with hydrogen under a hydrogen absolute pressure of 73 kPa at 150° C. for 15 hours. At the end of this time, the reactor was cooled to 25° C., and there was obtained and isolated under an argon atmosphere a solid metal compound (W, Ni/Al-2) according to the invention, comprising an organometallic tungsten hydride (C1) and a nickel compound (C2) supported on and grafted onto the alumina support, and containing 3.6 wt % of tungsten and 0.9 wt % of nickel.

### EXAMPLE 3

### Preparation of a Solid Metal Compound (W, Ni/Al-3) Comprising Tungsten and Nickel Compounds and an Aluminium Oxide Support

A solid metal compound (W, Ni/Al-3) was prepared exactly as in Example 1, apart from (i) using an aqueous solution containing 184 mg of nickel sulphate hexahydrate (NiSO₄, 6 H₂O) used as a precursor (Pr2) instead of 46 mg in the first stage, (ii) using a n-pentane solution containing 120 mg of tungsten tris(neopentyl) neopentylidyne as an organometallic precursor (Pr1) instead of 150 mg in the fourth stage, and (iii) using 900 mg of the organometallic tungsten compound supported on and grafted onto the alumina support containing the nickel compound instead of 600 mg in the fifth stage. A solid metal compound (W, Ni/Al-3) according to the invention, comprising an organometallic tungsten hydride (C1) and a nickel compound (C2) supported on and grafted onto the alumina support, was thus obtained and contained 2.9 wt % of tungsten and 4 wt % of nickel.

### EXAMPLE 4

### Preparation of a Solid Metal Compound (W, Ni/Al-4) Comprising Tungsten and Nickel Compounds and an Aluminium Oxide Support

In a first stage, there were introduced into a glass reactor with stirring at 25° C., 1 g of a γ-alumina (gammα-alumina) identical to that used as a solid support in Example 1, and 5 ml of an aqueous solution containing 184 mg of nickel sulphate hexahydrate (NiSO₄, 6 H₂O) used as a precursor (Pr2). The mixture thus obtained was maintained under stirring at 25° C. for 1 hour. At the end of this time, a water suspension of the alumina support impregnated with nickel sulphate was obtained. The nickel impregnated alumina support was then separated from water and subjected to a treatment comprising drying and calcination carried out in a dry air current at 500° C. for 3 hours and to a desorption treatment carried out under vacuum at 500° C. for 2 hours, so as to obtain a nickel compound supported on the alumina support (Ni/Al) containing 4 wt % of nickel.

In a second stage, a solid metal compound (W/Al) was prepared exactly as in Example 6 (comparative), apart from using a n-pentane solution containing 120 mg of tungsten tris(neopentyl) neopentylidyne as a precursor (Pr) having the general formula (10) instead of 80 mg in the first stage. A solid organometallic tungsten hydride (W/Al) supported on and grafted onto the alumina support was thus obtained under an argon atmosphere and contained 4.95 wt % of tungsten.

In a third stage, 500 mg of the nickel compound (Ni/Al) previously obtained in the first stage were mixed with 400 mg of the solid organometallic tungsten hydride (W/Al) previously obtained in the second stage, in a glass reactor under stirring under an argon atmosphere at 25° C. for 1 hour. At the end of this time, a solid metal compound (W, Ni/Al-4) according to the invention, comprising an organometallic tungsten hydride (C1) and a nickel compound (C2) supported on and grafted onto the alumina support, was thus obtained and contained 2.2 wt % of tungsten and 2.2 wt % of nickel.

### EXAMPLE 5

### Preparation of a Solid Metal Compound (W, Pt/Al) Comprising Tungsten and Platinum Compounds and an Aluminium Oxide Support

In a first stage, a powder containing 5 wt % of platinum supported on alumina, sold under the commercial reference “Escat 2941”® by Strem (USA), was dried under a dry air current at 500° C. for 3 hours. The powder thus dried was then subjected to a reduction treatment carried out by subjecting said powder to a current of hydrogen in a continuous flow reactor at 400° C. under a hydrogen absolute pressure of 10² kPa for 20 hours. At the end of this time, a reduced platinum compound supported on the alumina was thus obtained and then subjected to a hydrogen desorption carried out under vacuum at 400° C. for 4 hours.

In a second stage, there were introduced into a glass reactor under an argon atmosphere at 25° C., 1.8 g of the supported platinum compound previously obtained, followed by a n-pentane solution containing 100 mg of tungsten tris(neopentyl) neopentylidyne used as an organometallic precursor (Pr1) and having the general formula (10).

The mixture thus obtained was heated to 66° C. and maintained at this temperature for 3 hours. At the end of this time, the mixture was cooled to 25° C., and an organometallic tungsten compound supported on and grafted onto the alumina support containing the platinum compound was obtained. The excess of the organometallic precursor (Pr1) which had not reacted, was removed by washing with n-pentane at 25° C. The organometallic tungsten compound thus supported on and grafted onto the alumina support containing the platinum compound was then dried under a vacuum treatment.

In a third stage, 1.2 g of the organometallic tungsten compound supported on and grafted onto the alumina support containing the platinum compound as previously obtained were isolated in a glass reactor and subjected to a hydrogenolysis treatment by contacting said tungsten compound with hydrogen under a hydrogen absolute pressure of 73 kPa at 150° C. for 15 hours. At the end of this time, the reactor was cooled to 25° C., and there was obtained and isolated under an argon atmosphere a solid metal compound (W, Pt/Al) according to the invention, comprising an organometallic tungsten hydride (C1) and a platinum compound (C2) supported on and grafted onto the alumina support, and containing 1.2 wt % of tungsten and 5.0 wt % of platinum.

### EXAMPLE 6 (COMPARATIVE)

### Preparation of a Solid Metal Compound (W/Al) Comprising a Tungsten Compound and an Aluminium Oxide Support

In the present comparative example, 530 mg of a γ-alumina (gamma-alumina) identical to that used as a solid support in Example 1 were subjected to a calcination treatment carried out by contacting said alumina with a current of dry air at 500° C. for 15 hours, and then to a dehydroxylation treatment carried out by subjecting the alumina support thus calcined to a vacuum treatment under an absolute pressure of 10⁻² Pa at 500° C. for 15 hours.

In a first stage, there were introduced into a glass reactor with stirring under an argon atmosphere and at 25° C., the alumina previously treated and a n-pentane solution containing 80 mg of tungsten tris(neopentyl)neopentylidyne used as a precursor (Pr) and having the general formula (10).The mixture thus obtained was kept at 25° C. for 3 hours. At the end of this time, an organometallic tungsten compound supported on and grafted onto the alumina support was obtained. The excess of the precursor (Pr) which had not reacted, was removed from the supported and grafted organometallic tungsten compound by washing with n-pentane at 25° C. The supported and grafted organometallic tungsten compound was then dried under vacuum and contained 3.5 wt % of tungsten.

In a second stage, 40 mg of the previously obtained organometallic tungsten compound supported on and grafted onto the alumina support were isolated in a glass reactor and subjected to a hydrogenolysis treatment by contacting said tungsten compound with hydrogen under a hydrogen absolute pressure of 73 kPa at 150° C. for 15 hours. At the end of this time, the reactor was cooled to 25° C., and there was obtained and isolated under an argon atmosphere a solid organometallic tungsten hydride supported on and grafted onto the alumina support (W/Al) containing 3.5 wt % of tungsten.

### EXAMPLE 7

### Preparation of a Solid Metal Compound (Ta, Co/Al) Comprising Tantalum and Cobalt Compounds and an Aluminium Oxide Support

In a preliminary stage, 1 g of a γ-alumina (gamma-alumina) identical to that used as a support in Example 1, was subjected to a calcination treatment carried out by contacting said alumina with a current of dry air at 500° C. for 15 hours, and then to a dehydroxylation treatment carried out by subjecting the alumina thus calcined to a vacuum under an absolute pressure of 10⁻² Pa at 500° C. for 15 hours.

In a first stage, there were introduced into a glass reactor under an argon atmosphere at 25° C., the alumina support previously obtained and simultaneously:
(i) a n-pentane solution containing 145 mg of tantalum tris(neopentyl) neopentylidene used as an organometallic precursor (Pr1) having the general formula (13):

Ta[—CH₂—C(CH₃)₃]₃[═CH—C(CH₃)₃] (13)
(ii) and a n-pentane solution containing 75 mg of cobalt tetra(norbornyl) used as a precursor (Pr2) having the general formula (14):

Co[—C₇H₁₁]₄ (14)

The mixture thus obtained was kept at 25° C. for 3 hours. At the end of this time, organometallic Ta/Co compounds supported on and grafted onto the alumina support was obtained. The excess of the precursors (Pr1) and (Pr2) which had not reacted, was removed from the organometallic Ta/Co compounds supported on and grafted onto the alumina support by washing with n-pentane at 25° C. The organometallic Ta/Co compounds thus supported and grafted were dried under vacuum, and contained 3.5 wt % of tantalum and 0.8 wt % of cobalt.

In a second stage, 600 mg of the organometallic Ta/Co compounds supported on and grafted onto the alumina support as previously obtained were isolated in a glass reactor and subjected to a hydrogenolysis treatment carried out by contacting said Ta/Co compounds with hydrogen under a hydrogen absolute pressure of 73 kPa at 150° C. for 15 hours. At the end of this time, the reactor was cooled to 25° C., and there was obtained and isolated under an argon atmosphere a solid metal compound (Ta, Co/Al) according to the invention, comprising an organometallic tantalum hydride (C1) and a cobalt compound (C2) supported on and grafted onto the alumina support, and containing 3.5 wt % of tantalum and 0.8 wt % of cobalt.

### EXAMPLE 8 (COMPARATIVE)

### Preparation of a Solid Metal Compound (Ta/Al) Comprising a Tantalum Compound and an Aluminium Oxide Support

In the present comparative example, the preparation of a solid metal compound (Ta/Al) comprising a tantalum compound and an aluminium oxide support was carried out exactly as for the solid metal compound (Ta, Co/Al) in Example 7, apart from not using cobalt tetra(norbornyl) as a precursor (Pr2) in the first stage,

The solid metal compound (Ta/Al) thus obtained comprised an organometallic tantalum hydride supported on and grafted onto the alumina support, containing 3.5 wt % of tantalum.

### EXAMPLE 9

### Preparation of a Solid Metal Compound (Mo, Ni/Al) Comprising Molybdenum and Nickel Compounds and an Aluminium Oxide Support.

A solid metal compound (Mo, Ni/Al) was prepared exactly as in Example 1, apart from using a n-pentane solution containing 120 mg of molybdenum tris(neopentyl) neopentylidyne used as an organometallic precursor (Pr1) having the general formula (15):

Mo[—CH₂—C(CH₃)₃]₃[≡C—C(CH₃)₃] (15)

instead of the n-pentane solution containing 150 mg of tungsten tris(neopentyl) neopentylidyne in the fourth stage.

In the fifth stage, 600 mg of the organometallic molybdenum compound supported on and grafted onto the alumina support containing a nickel compound were isolated in a glass reactor and subjected to a hydrogenolysis treatment by contacting said molybdenum compound with hydrogen under a hydrogen absolute pressure of 73 kPa at 150° C. for 15 hours. At the end of this time, the reactor was cooled to 25° C., and there was obtained and isolated under an argon atmosphere a solid metal compound (Mo, Ni/Al) according to the invention, comprising an organometallic molybdenum hydride (C1) and a nickel compound (C2) supported on and grafted onto the alumina support, and containing 2 wt % of molybdenum and 1 wt % of nickel.

### EXAMPLE 10 (COMPARATIVE)

### Preparation of a Solid Metal Compound (Mo/Al) Comprising a Molybdenum Compound and an Aluminium Oxide Support

In the present comparative example, the preparation of a solid metal compound (Mo/Al) comprising a molybdenum compound and an aluminium oxide support was carried out exactly as for the solid metal compound (W/Al) prepared in Example 6 (comparative), apart from using a n-pentane solution containing 70 mg of molybdenum tris(neopentyl) neopentylidyne used as a precursor (Pr) having the general formula (15) instead of 80 mg of tungsten tris(neopentyl) neopentylidyne in the first stage.

In the second stage, 40 mg of the previously obtained organometallic molybdenum compound supported on and grafted onto the alumina support were isolated in a glass reactor and subjected to a hydrogenolysis treatment by contacting said molybdenum compound with hydrogen under a hydrogen absolute pressure of 73 kPa at 150° C. for 15 hours. At the end of this time, the reactor was cooled to 25° C., and there was obtained and isolated under an argon atmosphere a solid organometallic molybdenum compound supported on and grafted onto the alumina support (Mo/Al) containing 1.8 wt % of molybdenum.

### EXAMPLE 11

### Preparation of a Solid Metal Compound (Re, Fe/Al) Comprising Rhenium and Iron Compounds and an Aluminium Oxide Support

A solid metal compound (Re, Fe/Al) was prepared exactly as in Example 2, apart from using as organometallic precursors (Pr1) and (Pr2), respectively
(i) the rhenium neopentyl neopentylidene neopentylidyne of the general formula (16):

Re[—CH₂—C(CH₃)₃] [═CH—C(CH₃)₃] [≡C—C(CH₃)₃] (16)

instead of the tungsten tris(neopentyl) neopentylidyne, and
(ii) the iron bis(mesityl) of the general formula (17):

{Fe [2,4,6-(CH₃)₃C₆H₂]₂}₂ (17)

instead of the nickel bis(meta-allyl) in the first stage.

At the end of the first stage, there were obtained organometallic Re/Fe compounds supported on and grafted onto the alumina support, containing 3.7 wt % of rhenium and 0.95 wt % of iron.

In a second stage, 600 mg of the organometallic Re/Fe compounds supported on and grafted onto the alumina support as previously obtained were isolated in a glass reactor and subjected to a hydrogenolysis treatment carried out under conditions identical to those of the second stage of Example 2. At the end of the second stage, there was obtained a solid metal compound (Re, Fe/Al) according to the invention, comprising an organometallic rhenium hydride (C1) and an iron compound (C2) supported on and grafted onto the alumina support, and containing 3.7 wt % of rhenium and 0.95 wt % of iron.

### EXAMPLE 12

### Process for Converting Isobutene into Neohexene in the Presence of the Solid Metal Compound (W, Ni/Al-1)

Into a dynamic reactor having a capacity of 5 ml, heated to 150° C. and containing 500 mg of the solid metal compound (W, Ni/Al-1) prepared in Example 1, isobutene was continuously introduced at a rate of 1.52 moles of isobutene per mole of tungsten of the solid metal compound and per minute, under a total absolute pressure of 0.1 MPa. Under these conditions, isobutene was converted into neohexene (i.e. 3,3-dimethyl-1-butene) and 2,3-dimethyl-1-butene, and after 1000 minutes of reaction, the activity (TON) and the neohexene molar selectivity (molar _{selectivity}₍ₙₑₒₕₑₓₑₙₑ₎) of the solid metal compound (W, Ni/Al-1) were measured and calculated respectively as follows:
the activity of the solid metal compound is determined by the turn over number (TON) calculated according to equation (10):

TON=(number of moles of isobutene having reacted)/(number of moles of tungsten) (10)

and
the neohexene molar selectivity (molar selectivity(neohexene)) is calculated according to equation (11):

molar selectivity₍ₙₑₒₕₑₓₑₙₑ₎=100×(number of moles of neohexene produced)/(total number of moles of all the hydrocarbons produced) (11)

Thus, the results of these measurements and calculations in the present example are as follows:
TON=280, and
molar selectivity₍ₙₑₒₕₑₓₑₙₑ₎=40%.

### EXAMPLE 13 (COMPARATIVE)

### Process for Converting Isobutene into Neohexene in the Presence of the Solid Metal Compound (W/Al)

In the present comparative example, the same process was carried out exactly as in Example 12, apart from using the solid metal compound (W/Al) prepared in Example 6 (comparative), instead of the solid metal compound (W, Ni/Al-1) prepared in Example 1.

Under these conditions, isobutene was converted into neohexene and 2,3-dimethyl-1-butene, and after 1000 minutes of reaction, the activity (TON) and the neohexene molar selectivity (molar selectivity₍ₙₑₒₕₑₓₑₙₑ₎) of the solid metal compound (W/Al) were measured and calculated respectively according to equations (10) and (11):
TON=230, and
molar selectivity₍ₙₑₒₕₑₓₑₙₑ₎=10%

It was observed that the activity (TON) of the solid metal compound (W/Al) in the present comparative example was substantially lower than that of the solid metal compound (W, Ni/Al-1) in Example 12, while the neohexene molar selectivity (molar selectivity₍ₙₑₒₕₑₓₑₙₑ₎) in the present comparative example was drastically lower (by a factor of four times) than that obtained in Example 12 with the solid metal compound (W, Ni/Al-1).

### EXAMPLE 14

### Process for Converting Isobutene into Neohexene in the Presence of the Solid Metal Compound (W, Ni/Al-2)

In the present example, the same process was carried out exactly as in Example 12, apart from using the solid metal compound (W, Ni/Al-2) prepared in Example 2, instead of the solid metal compound (W, Ni/Al-1) prepared in Example 1.

Under these conditions, isobutene was converted into neohexene and 2,3-dimethyl-1-butene, and after 1000 minutes of reaction, the activity (TON) and the neohexene molar selectivity (molar selectivity₍ₙₑₒₕₑₓₑₙₑ₎) of the solid metal compound (W, Ni/Al-2) were measured and calculated respectively according to equations (10) and (11):
TON=270, and
molar selectivity₍ₙₑₒₕₑₓₑₙₑ₎=35%.

It was observed that the activity (TON) of the solid metal compound (W, Ni/Al-2) in the present example was substantially higher than that obtained in Example 13 (comparative) with the solid metal compound (W/Al), while the neohexene molar selectivity (molar selectivity₍ₙₑₒₕₑₓₑₙₑ₎ in the present example was very substantially higher than that obtained in Example 13 (comparative) with the solid metal compound (W/Al).

### EXAMPLE 15

### Process for Converting Isobutane into 2,3-Dimethylbutane in the Presence of the Solid Metal Compound (W, Pt/Al)

Into a dynamic reactor having a capacity of 5 ml, heated to 150° C. and containing 1.2 g of the solid metal compound (W, Pt/Al) prepared in Example 5, isobutane was continuously introduced at a rate of 2.3 moles of isobutane per mole of tungsten of the solid metal compound and per minute, under a total absolute pressure of 0.1 MPa.

Under these conditions, isobutane was converted into 2,3-dimethylbutane, and after 2500 minutes of reaction, the activity (TON) and the 2,3-dimethylbutane molar selectivity (molar selectivity_{(2,3-dimethylbutane)} of the solid metal compound (W, Pt/Al) were measured and calculated respectively as follows:
the activity of the solid metal compound is determined by the turn over number (TON) calculated according to equation (12):

TON=(number of moles of isobutane having reacted)/(number of moles of tungsten) (12)

and
the 2,3-dimethylbutane molar selectivity (molar selectivity_{(2,3-dimethylbutane)}) is calculated according to equation (13):

molar selectivity_{(2,3-dimethylbutane)}=100×(number of moles of 2,3-dimethylbutane produced)/(total of moles of all the hydrocarbons produced) (13)

Thus, the results of these measurements and calculations in the present example are as follows:
TON=60, and
molar selectivity_{(2,3-dimethylbutane)}=41%.

### EXAMPLE 16 (COMPARATIVE)

### Process for Converting Isobutane into 2,3-Dimethylbutane in the Presence of the Solid Metal Compound (W/Al).

In the present comparative example, the same process was carried out exactly as in Example 15, apart from using the solid metal compound (W/Al) prepared in Example 6 (comparative), instead of the solid metal compound (W, Pt/Al) prepared in Example 5.

Under these conditions, isobutane was converted into 2,3-dimethylbutane, and after 2500 minutes of reaction, the activity (TON) and the 2,3-dimethylbutane molar selectivity (molar selectivity_{(2,3-dimethylbutane)} of the solid metal compound (W/Al) were measured and calculated respectively according to equations (12) and (13):
TON=31, and
molar selectivity_{(2,3-dimethylbutane)}=41%.

It was observed that the activity (TON) of the solid metal compound (W/Al) in the present comparative example was drastically lower (by a factor of about two times) than that of the solid metal compound (W, Pt/Al) in Example 15, while the 2,3-dimethylbutane molar selectivity (filolar selectivity_{(2,3-dimethyibutane)} in the present comparative example was identical to that of the solid metal compound (W, Pt/Al) obtained in Example 15.

### EXAMPLE 17

### Process for Converting Isobutane into 2,3-Dimethylbutane in the Presence of the Solid Metal Compound (Ta, Co/Al)

In the present example, the same process was carried out exactly as in Example 15, apart from using the solid metal compound (Ta, Co/Al) prepared in Example 7, instead of the solid metal compound (W, Pt/Al) prepared in Example 5, and from introducing isobutane at a rate identical and equal to 2.3, but expressed in moles of isobutane per mole of tantalum of the solid metal compound and per minute (instead of moles of isobutane per mole of tungsten of the solid metal compound and per minute). In addition, the activity of the solid metal compound (Ta, Co/Al) is determined in the present example by the turn over number (TON) calculated according to equation (14):

TON=(number of moles of isobutane having reacted)/(number of moles of tantalum) (14)

Under these conditions, isobutane was converted into 2,3-dimethylbutane, and after 2500 minutes of reaction, the activity (TON) and the 2,3-dimethylbutane molar selectivity (molar selectivity_{(2,3-dimethylbutane)}) of the solid metal compound (Ta, Co/Al) were measured and calculated respectively according to equations (14) and (13):
TON=45, and
molar selectivity(2,3-dimethylbutane)=17%.

### EXAMPLE 18 (COMPARATIVE)

### Process for Converting Isobutane into 2,3-Dimethylbutane in the Presence of the Solid Metal Compound (Ta/Al)

In the present comparative example, the same process was carried out exactly as in Example 17, apart from using the solid metal compound (Ta/Al) prepared in Example 8 (comparative), instead of the solid metal compound (Ta, Co/Al) prepared in Example 7

Under these conditions, isobutane was converted into 2,3-dimethylbutane, and after 2500 minutes of reaction, the activity (TON) and the 2,3-dimethylbutane molar selectivity (molar selectivity_{(2,3-dimethylbutane)}) of the solid metal compound (Ta/Al) were measured and calculated respectively according to equations (14) and (13):
TON=28, and
molar selectivity_{(2,3-dimethylbutane)}=16%.

It was observed that the activity (TON) of the solid metal compound (Ta/Al) in the present comparative example was drastically lower (by a factor of about two times) than that of the solid metal compound (Ta, Co/Al) in Example 17, while the 2,3-dimethylbutane molar selectivity (molar selectivity_{(2,3-dimethylbutane)}) in the present comparative example was similar to that of the solid metal compound (Ta, Co/Al) obtained in Example 17.

### EXAMPLE 19

### Process for Converting Ethylene into Propylene in the Presence of the Solid Metal Compound (W, Ni/Al-4).

Into a dynamic reactor having a capacity of 5 ml, heated to 150° C. and containing 900 mg of the solid metal compound (W, Ni/Al-4) prepared in Example 4, ethylene was continuously introduced at a rate of 1.66 moles of ethylene per mole of tungsten of the solid metal compound and per minute, under a total absolute pressure of 0.1 MPa.

Under these conditions, it was observed that ethylene was converted into propylene, and after 1000 minutes of reaction, the activity (TON) and the propylene molar selectivity (molar selectivity_{(propylene)}) of the solid metal compound (W, Ni/Al-4) were measured and calculated respectively as follows:
the activity of the solid metal compound is determined by the turn over number (TON) calculated according to equation (15):

TON=(number of ethylene having reacted)/(number of moles of tungsten) (15)

and
the propylene molar selectivity (molar selectivity_{(propylene)}) is calculated according to equation (16):

molar selectivity_{(propylene)}=100×(number of moles of propylene produced)/(total of moles of all the hydrocarbons produced) (16)

Thus, the results of these measurements and calculationg in the present example are as follows:
TON=570, and
Molar selectivity_{(propylene)}=90%.

### EXAMPLE 20

### Process for Converting Ethylene into Propylene in the Presence of the Solid Metal Compound (W, Ni/Al-3)

In the present example, the same process was carried out exactly as in Example 19, apart from using 660 mg of the solid metal compound (W, Ni/Al-3) prepared in Example 3, instead of 900 mg of the solid metal compound (W, Ni/Al-4) prepared in Example 4.

Under these conditions, ethylene was converted into propylene, and after 1000 minutes of reaction, the activity (TON) and the propylene molar selectivity (molar selectivity_{(propylene)} of the solid metal compound (W, Ni/Al-3) were measured and calculated respectively according to equations (15) and (16):
TON=430, and
molar selectivity_{(propylene)}=88%.

### EXAMPLE 21 (COMPARATIVE)

### Process for Converting Ethylene into Propylene in the Presence of the Solid Metal Compound (W/Al)

In the present comparative example, the same process was carried out exactly as in Example 19, apart from using the solid metal compound (W/Al) prepared in Example 6 (comparative), instead of the solid metal compound (W, Ni/Al-4) prepared in Example 4.

Under these conditions, ethylene was converted into propylene, and after 1000 minutes of reaction, the activity (TON) and the propylene molar selectivity (molar selectivity_{(propylene)}) of the solid metal compound (W/Al) were measured and calculated respectively according to equations (15) and (16):
TON=215, and
molar selectivity_{(propylene)}=93%.

It was observed that the activity (TON) of the solid metal compound (W/Al) in the present comparative example was drastically lower (by a factor of at least two times) than that of the solid metal compounds (W, Ni/Al-4) and (W, Ni/Al-3) respectively in Examples 19 and 20, while the propylene molar selectivity (molar selectivit the present comparative example was relatively similar to or slightly higher than that of the solid metal compounds (W, Ni/Al-4) and (W, Ni/Al-3) obtained in Examples 19 and 20.

### EXAMPLE 22

### Process for Converting Ethylene into Propylene in the Presence of the Solid Metal Compound (Mo, Ni/Al)

In the present example, the same process was carried out exactly as in Example 19, apart from using the solid metal compound (Mo, Ni/Al) prepared in Example 9 instead of the solid metal compound (W, Ni/Al-4) prepared in Example 4, and from introducing ethylene at a rate identical and equal to 1.66, but expressed in moles of ethylene per mole of molybdenum of the solid metal compound and per minute (instead of moles of ethylene per mole of tungsten of the solid metal compound and per minute). In addition, the activity of the solid metal compound (Mo, Ni/Al) is determined in the present example by the turn over number (TON) calculated according to equation (17):

TON=(number of moles of ethylene having reacted)/(number of moles of molybdenum) (17)

Under these conditions, ethylene was converted into propylene, and after 1000 minutes of reaction, the activity (TON) and the propylene molar selectivity (molar selectivity_{(propylene)}) of the solid metal compound (Mo, Ni/Al) were measured and calculated respectively according to equations (17) and (16):
TON=300, and
molar selectivity_{(propylene)}=81%.

### EXAMPLE 23 (COMPARATIVE)

### Process for Converting Ethylene into Propylene in the Presence of the Solid Metal Compound (Mo/Al)

In the present comparative example, the same process was carried out exactly as in

Example 22, apart from using the solid metal compound (Mo/Al) prepared in Example 10 (comparative), instead of the solid metal compound (Mo, Ni/Al) prepared in Example 9.

Under these conditions, ethylene was converted into propylene, and after 1000 minutes of reaction, the activity (TON) and the propylene molar selectivity (molar selectivity_{(propylene)}) of the solid metal compound (Mo/Al) were measured and calculated respectively according to equations (17) and (16):
TON=150, and
molar selectivity_{(propylene)}=85%.

It was observed that the activity (TON) of the solid metal compound (Mo/Al) in the present comparative example was drastically lower (by a factor of two times) than that of the solid metal compound (Mo, Ni/Al) in Example 22, while the propylene molar selectivity (molar selectivity_{(propylene)} in the present comparative example was relatively similar to or slightly higher than that of the solid metal compound (Mo, Ni/Al) obtained in Example 22.

### EXAMPLE 24

### Process Comprising Propane Metathesis in the Presence of the Solid Metal Compound (Ta, Co/Al)

Into a dynamic reactor having a capacity of 5 ml, heated to 150° C. and containing 500 mg of the solid metal compound (Ta, Co/Al) prepared in Example 7, propane was continuously introduced at a rate of 1.52 moles of propane per mole of tantalum of the solid metal compound and per minute, under a total absolute pressure of 0.1 MPa. Under these conditions, it was observed that propane was converted into a mixture of ethane and butanes containing very minor amounts of methane, pentanes and hexanes, with a high activity and very high molar selectivities respectively into ethane and butanes.

### EXAMPLE 25

### Process Comprising Ethane Metathesis in the Presence of the Solid Metal Compound (Re, Fe/Al)

Into a dynamic reactor having a capacity of 5 ml, heated to 150° C. and containing 500 mg of the solid metal compound (Re, Fe/Al) prepared in Example 11, ethane was continuously introduced at a rate of 1.52 moles of ethane per mole of rhenium of the solid metal compound and per minute, under a total absolute pressure of 0.1 MPa. Under these conditions, it was observed that ethane was essentially converted into a mixture of methane and propane containing very minor amounts of butanes and pentanes, with a high activity and very high molar selectivities respectively into methane and propane.

1-33. (canceled)

34. Catalyst for manufacturing saturated or unsaturated hydrocarbon(s) having a modified carbon skeleton, comprising (i) a solid support in the form of particles comprising aluminium oxide, (ii) at least one first metal compound (C1) supported on the solid support particles and selected from metal hydrides, organometallic compounds and organometallic hydrides, and comprising a metal (M1) selected from the lanthanides, the actinides and the metals of Groups 4 to 7 of the Periodic Table of the Elements, and (iii) at least one second metal compound (C2) comprising a metal (M2) selected from the metals of Groups 8 to 10 of said Table and being supported on the same solid support particles as those containing said compound (C1), or different from those containing said compound (C1), the solid support being of a same type or different types.

35. Catalyst according to claim 34, characterised in that the solid support is chosen from aluminium oxide, mixed aluminium oxides and modified aluminium oxides.

36. Catalyst according to claim 34, characterised in that the first metal compound (C1) comprises a metal (M1) selected from Groups 4 to 7 of the Periodic Table of the Elements.

37. Catalyst according to claim 34, characterised in that the first metal compound (C1) comprises a metal (M1) selected from lanthanum, cerium, neodymium, samarium, lutetium, titanium, zirconium, hafnium, vanadium, niobium, tantalum, chromium, molybdenum, tungsten and rhenium.

38. Catalyst according to claim 34, characterised in that the first metal compound (C1) is grafted onto the solid support.

39. Catalyst according to claim 34, characterised in that the second metalcompound (C2) comprises a metal (M2) selected from iron, ruthenium, osmium, cobalt, rhodium, iridium, nickel, palladium and platinum.

40. Catalyst according to claim 34, characterised in that the second metal compound (C2) comprises a metal (M2) having a formal oxidation state selected from −4 to +8.

41. Catalyst according to claim 34, characterised in that the second metal compound (C2) is selected from metal hydrides, organometallic compounds and organometallic hydrides.

42. Catalyst according to claim 34 characterised in that the second metal compound (C2) is grafted onto the solid support.

43. Catalyst according to claim 34, characterised in that the weight percentage of the metal (M1) in said catalyst is selected from 0.1 to 15%.

44. Catalyst according to claim 34, characterised in that the weight percentage of the metal (M2) in said catalyst is selected from 0.1 to 15%.

45. Catalyst according to claim 34, characterised in that the molar ratio of the metal (M1) to the metal (M2) in said catalyst is selected from 1:100 to 100:1.

46. Process for preparing the catalyst according to claim 34, characterised in that it comprises
stage (1) comprising dispersing (i) an organometallic precursor (Pr1) comprising the metal (M1) linked to one or more hydrocarbon radicals (R) and (ii) a precursor (Pr2) comprising the metal (M2), onto the solid support comprising aluminium oxide; either simultaneously or separately; and optionally
stage (2) comprising contacting the solid metal compound obtained in stage (1) with hydrogen and/or a reducing agent.

47. Process according to claim 46, characterised in that prior to stage (1), the solid support is subjected to a preliminary stage comprising calcination and/or dehydroxylation of the support.

48. Process according to claim 46, characterised in that dispersing the organometallic precursor (Pr1) and the precursor (Pr2) onto the solid support is carried out by a method selected from sublimation, impregnation and dry mixing.

49. Process according to claim 46, characterised in that the precursor (Pr2) is selected from organometallic precursors comprising the metal (M2) linked to one or more hydrocarbon radicals (R) identical to or different from those of the organometallic precursor (Pr1).

50. Process according to claim 46, characterised in that the precursor (Pr2) is selected from metal (M2) organic salts and metal (M2) inorganic salts.

51. Process for preparing the catalyst according to claim 34, characterised in that it comprises:
stage (a) comprising impregnating the solid support with an aqueous solution of a precursor (Pr2) comprising a metal (M2) salt,
stage (b) comprising drying and subjecting to calcination and optionally to dehydroxylation the solid product obtained in stage (a),
stage (c) comprising reducing the metal (M2) by contacting the solid product obtained in stage (b) with hydrogen and/or a reducing agent, optionally stage (d) comprising desorbing hydrogen from the solid product obtained in stage (c) when hydrogen is used,
stage (e) comprising dispersing an organometallic precursor (Pr1) comprising the metal (M1) linked to one or more hydrocarbon radicals (R) onto the solid product obtained in stage (c) or (d), and optionally
stage (f) comprising contacting the solid metal compound obtained in stage (e) with hydrogen.

52. Process for preparing the catalyst according to claim 34, characterised in that it comprises:
stage (i) comprising preparing the first metal compound (C1),
stage (ii) comprising preparing the second metal compound (C2), and
stage (iii) comprising mixing the first and second metal compounds (C1) and (C2).

53. Catalyst according to claim 34, characterised in that it is used for a process involving hydrocarbon reactions and comprising contacting said catalyst with one or more starting hydrocarbons optionally in the presence of hydrogen, involving the splitting and recombining of carbon-carbon and/or carbon-hydrogen and/or carbon-metal bonds, and producing final hydrocarbon(s) different from the starting hydrocarbons.

54. Catalyst according to claim 34, characterised in that it is used for a process manufacturing saturated or unsaturated hydrocarbon(s) having a modified carbon skeleton, comprising contacting at least one saturated or unsaturated aliphatic hydrocarbon with itself, or with at least one other saturated or unsaturated aliphatic hydrocarbon, or with at least one aromatic hydrocarbon substituted by at least one hydrocarbon radical, or with at least one saturated or unsaturated alicyclic hydrocarbon substituted by at least one hydrocarbon radical, in the presence of said catalyst and optionally of hydrogen.

55. Catalyst according to claim 34, characterised in that it is used for a process involving alkane metathesis reactions selected from metathesis reactions of an alkane with itself, and metathesis reactions of an alkane with at least one other alkane.

56. Catalyst according to claim 34, characterised in that it is used for a process converting isobutane into 2,3-dimethylbutane.

57. Catalyst according to claim 34, characterised in that it is used for a process involving alkene metathesis reactions selected from metathesis reactions of an alkene with itself, and metathesis reactions of an alkene with at least one other alkene.

58. Catalyst according to claim 34, characterised in that it is used for a process S converting isobutene into neohexene.

59. Catalyst according to claim 34, characterised in that it is used for a process converting ethylene into propylene.

60. Catalyst according to claim 34, characterised in that it is used for a process comprising alkene oligomerisation.

61. Catalyst according to claim 34, characterised in that it is used for a process comprising a non-oxidative coupling reaction of methane.

62. Catalyst according to claim 34, characterised in that it is used for a process comprising a methane-olysis reaction carried out by contacting methane with at least one other aliphatic hydrocarbon, or with at least one aromatic or alicyclic hydrocarbon substituted by at least one hydrocarbon radical.

63. Catalyst according to claim 34, characterised in that it is used for a process comprising methane-olysis reactions carried out by contacting methane with natural gas, liquefied petroleum gas, wet gas, wet natural gas, natural-gas liquid or cuts of light hydrocarbon selected from C1 to C6, from C1 to C5, from C1 to C4, from C1 to C3 or from C1 to C2.

64. Catalyst according to claim 34, characterised in that it is used for a process comprising a cross-metathesis reaction between said catalyst and at least one starting hydrocarbon.

65. Catalyst according to claim 34, characterised in that it is used for a process comprising a hydrocarbon hydrogenolysis reaction carried out by contacting at least one hydrocarbon with hydrogen.

66. Catalyst according to claim 65, characterised in that the hydrocarbon is selected from saturated hydrocarbon, hydrocarbon polymers or oligomers, and waxes.
